(19) United States
(12) Patent Application Publication
(10) Pub. No.: US 2003/0184707 A1
(43) Pub. Date: Oct. 2, 2003

(54) Process for producing reflection type liquid crystal display device

(76) Inventors: Makoto Abe, Hitachi (JP); Masahiko Ando, Hitachinaka (JP); Shinichi Komura, Hitachi (JP); Etsuko Nishimura, Hitachiota (JP); Kazuhiro Ogawa, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/391,774

(22) Filed: Mar. 20, 2003

Related U.S. Application Data
(63) Continuation of application No. 10/103,780, filed on Mar. 25, 2002.

(30) Foreign Application Priority Data
Nov. 30, 2001 (JP) 2001-365907

(51) Int. Cl. G02F 1/13

(52) U.S. Cl. 349/187

(57) ABSTRACT

When reflection type liquid crystal display devices of different specifications of which pixel pitches or the like are different are produced, commonality of photo masks for at least one photo mask is provided to reduce production costs for producing reflection type liquid crystal display devices having different pixel pitches. In the reflection type liquid crystal display device, an island pattern is formed in matrix form in the same layer as a semiconductor layer of a thin film transistor. A specific regularity is provided in which a pitch of the island pattern in an extending direction of an image signal line is different from a pitch of pixel electrodes neighboring in the extending direction of the image signal line, and the pitch of the island pattern in the extending direction of a scan signal line is different from the pitch neighboring in the extending direction of the scan signal line.

### BACKGROUND OF THE INVENTION

The present invention relates to a liquid crystal display device, and in particularly a reflection type liquid display device and process for producing the same.

### PRIOR ART

Reflection type liquid crystal display devices having reflection electrodes as pixel electrodes, in active matrix mode in which thin film transistors (TFT) are provided as switching elements in a display area comprising pixels, have been abundantly proposed. The reflection type liquid crystal display device has a liquid crystal layer inserted in between a pair of substrates to hold this liquid crystal layer between the pair of substrates. The thin film transistor TFT, a reflection type pixel electrode, scan signal lines and image signal lines, and terminals for connecting the lines to external drive circuits, or the like are formed on one substrate (referred to as TFT substrate). A color filter (CF), a black matrix (BM) and a counter electrode (common electrode: CE) are formed on other substrate (referred to as CF substrate). The twist nematic mode is employed in which voltage is applied to between the pixel electrode and the counter electrode and switching of black-and-white display is carried out depending on whether or not an almost vertical longitudinal electric field is formed on the surface of the substrate.

When a reflection type liquid crystal display device in active matrix mode is produced, a plurality of photo masks for pattern-forming layers such as a semiconductor layer, electrode layer and line layer are required. When a reflection type liquid crystal display device having a different size of display screen and a different pitch of the pixel electrode is produced, it is necessary to newly prepare, (produce) photo masks in whole. In particular, the reflection type liquid crystal display device is often used in the display screen of a cellular phone and the display screen of a portable note type PC and PDA (personal data assistance). Because a great number of models of products need to be produced for cellular phones and PDAs, time required for designing and producing the photo mask and the production cost thereof tends to be increased.

In this respect, a method is described in JP-A-2000-258788 specification in which commonality of masks is provided when a plurality of liquid crystal display devices are produced between specifications with different sizes of display screen. This publication discloses a method comprising the steps of forming a plurality of scan signal lines at established intervals on the entire surface of the substrate, forming a plurality of image signal lines in such a manner that they cross the scan signal lines, and forming thin film transistors corresponding to areas where the scan signal lines are superimposed on the image signal lines, wherein in at least one of the step of forming the scan signal lines and the step of forming the image signal lines, and in the step of forming active elements, the scan signal lines, image signal lines and active elements are formed in a range larger than the display screen area regardless of the size of displayed pixels of the product.

Pixel electrodes are formed by photo masks for forming pixel electrodes consistent with the size of the display screen after formation of the above described structure, whereby masks when lines for scam signals, image signal lines and thin film transistors are formed, and processes for producing the same can be standardized even if the size of the display screen of the product is changed. This technique allows commonality of masks to be provided between specifications when products different in only the size of the display screen from one another are produced.

In the case where the pitch of pixel electrodes needs to be changed, however, the above described technique cannot be applied. In the step of producing the liquid crystal display device, the pixel electrode and the image signal line are normally formed on a same layer. If scan signal lines, image signal lines and thin film transistors are formed on the entire surface of the substrate as described in the above publication, a pad electrode connected to the external signal circuit cannot get over the image signal line, and thus the size of the area on which the pad electrode is formed is limited to the size no greater than that of the pixel.

A method in which a pad electrode having a same size as that of the pixel is formed, and is directly connected to the external signal circuit can be adopted if the size of the pixel area is large, but it is extremely difficult to connect the pad electrode to the external signal circuit if the interval between pixels is reduced.

The object of the present invention is to propose a structure enabling commonality of masks to be provided between products even if the pitch of the pixel electrode of the reflection type liquid crystal display device is changed, and allowing the shape of the pad electrode to be designed freely without no limitation associated with the size of pixels or the like.

### SUMMARY OF THE INVENTION

According to one aspect of the present invention is provided a method for producing a reflection type liquid crystal display device comprising a pair of substrates, a liquid crystal layer held between the pair of substrates, a common signal electrode formed on one of the above described pair of substrates and having transparency, a plurality of scan signal lines formed on the other substrate, a plurality of image signal lines substantially orthogonal to the scan signal lines, a thin film transistors formed at least on part of the areas near the points of intersection of the above described scan signal lines and the above described image signal lines and including semiconductor layers, source electrodes, gate electrodes and drain electrodes, a layer insulation film covering the above described scan signal lines, the above described image signal lines and the above described thin film transistors, through-holes formed in the layer insulation film, and reflection type pixel electrodes connected to the above described source electrodes via the through-holes,

wherein a photo mask for use in the case where at least two types of reflection type liquid crystal display devices are produced with a first specification and a second specification with a pixel pitch different from that of the first specification, which is used in at least one of a first step of forming the above described scan signal lines and the above described gate electrode, a second step of forming the above described semiconductor layer, and a third step of forming the above described image signal lines, the above described source electrode and the above described drain electrode, is commonly used in the above described first specification and the above described second specification.

According to the above method, commonality of photo masks can be provided between a first specification and a second specification different in pixel pitch from the first specification, thus making it possible to reduce production costs.

According to another aspect of the present invention is provided a method for producing a reflection type liquid crystal display device comprising a pair of substrates, a liquid crystal layer held between the pair of substrates, a common signal electrode formed on one of the above described pair of substrates and having transparency, a plurality of scan signal lines formed on the other substrate, a plurality of image signal lines substantially orthogonal to the scan signal lines, thin film transistors formed at least on part of the areas near the points of intersection of the above described scan signal lines and the above described image signal lines and including semiconductor layers, source electrodes, gate electrodes and drain electrodes, and reflection type pixel electrodes connected to the above described source electrodes, comprising the steps of:

(a) forming the above described scan signal lines and the above described gate electrode;

(b) forming semiconductor layers superimposed on the above described gate electrode;

(c) forming the above described scan signal lines, the above described image signal lines and the above described thin film transistors through the step of forming the above described image signal lines, the above described source electrodes and the above described drain electrodes; and

(d) forming a layer insulation film covering the above described thin film transistors, selectively forming through-holes through which the upper faces of the source electrodes are exposed to the layer insulation film, and forming pixel electrodes having desired pitches in the extending direction of the above described scan signal lines and the extending direction of the above described image signal lines on the above described layer insulation film including selected through-holes via the above described selected through-holes.

According to the above method for producing a reflection type liquid crystal display device, contact holes are selectively formed after production of components on the TFT substrate other than pixel electrodes, whereby the pixel electrodes can be produced with their pitches different from those of the above described components.

Therefore, commonality of photo masks can be provided between specifications having different pitches of pixel electrodes, thus making it possible to reduce production costs.

According to another aspect of the present invention is provided a reflection type liquid crystal display device comprising a pair of substrates, a liquid crystal layer held between the pair of substrates, a common signal electrode formed on one of the above described pair of substrates and having transparency, a plurality of scan signal lines formed on the other substrate, a plurality of image signal lines substantially orthogonal to the above described scan signal lines, thin film transistors formed at least on part of the areas near the points of intersection of the above described scan signal lines and the above described image signal lines and having semiconductor layers, source electrodes, gate electrodes and drain electrodes, and pixel electrodes connected to the above described thin film transistor and having a function as a reflecting plate, the reflection type liquid crystal display device further comprising:

an island pattern having a pitch different from at least one of the pitch of the above described pixel electrode neighboring in the extending direction of the above described image signal line and the pitch of the above described pixel electrodes neighboring in the extending direction of the above described scan signal line, the island pattern being formed in a matrix form on a same layer as the above described semiconductor layer and arranged with specific regularity.

According to the above reflection type liquid crystal display device, the island pattern formed on the same layer as the semiconductor layer has also specific regularity, thus making it possible to produce with a different specification a reflection type liquid crystal display device comprising pixel electrodes having a pitch different from that of the semiconductor layer in accordance with the regularity of the island pattern.

In addition, with respect to the scan signal line, image signal line, gate electrode, source electrode, drain electrode or the like, a reflection type liquid crystal display device having pixel electrodes having a different pitch can be produced with a different specification in accordance with the regularity.

The reason why commonality of photo masks can be provided when reflection type liquid crystal display devices of two specifications having different pitches of pixel electrodes are produced will be described below.

In the first specification, the gate electrode, semiconductor layer, drain electrode and source electrode of the thin film transistor, and the scan signal lines and the image signal lines are formed in the display area on the substrate in which the thin firm transistor is formed. At this time, invalid patters independent of the display function produced in the first specification and not connected to the external drive circuit are formed. The invalid pattern is at least one of an island pattern, transverse line pattern, longitudinal line pattern, transverse electrode pattern, longitudinal electrode pattern and cross electrode pattern. These invalid patterns do not function if the reflection type liquid crystal display device is produced with the first specification.

In the reflection type liquid crystal display device produced with the second specification with the pitch of the pixel electrode different from that of the reflection type liquid crystal display device produced with the first specification, these invalid patterns are formed so that they become valid patterns. Specifically, the island pattern, transverse line pattern, longitudinal line pattern, transverse electrode pattern, longitudinal electrode pattern and cross electrode pattern formed in the reflection type liquid crystal display device produced with the first specification function as the semiconductor layer of the thin film transistor, the image signal line, the scan signal line, the drain electrode, the gate electrode and the source electrode, respectively, in the reflection type liquid crystal display device produced with the second specification.

On the other hand, the semiconductor layer of the thin film transistor, the image signal line, the scan signal line, the drain electrode and the gate electrode in the first specification are equivalent to the island pattern, transverse line pattern, longitudinal line pattern, longitudinal electrode pattern, transverse electrode pattern and cross electrode pattern, respectively, which have practically no functions in the second specification.

Furthermore, patterns placed in the positions corresponding to common multiples of the pitch of respective pixel electrodes in the first and second specifications function as the semiconductor layer, the image signal line, the scan signal line, the drain electrode, the gate electrode and the source electrode in either the first or second specification as long as their reference positions are the same.

By adopting the above structure, commonality can be provided between the photo masks as described below for the first and second specifications.

More specifically, commonality can be provided between the photo mask forming an island pattern and the photo mask for use in the step of producing the semiconductor layer of the thin film transistor. Commonality can be provided between the photo mask forming the transverse line pattern and the photo mask for use in the step of forming the image signal line. Commonality can be provided between the photo mask forming the transverse electrode pattern and the photo mask for use in formation of the drain electrode. Commonality can be provided between the photo mask forming the longitudinal line pattern and the photo mask for use in the step of forming the scan signal line. Commonality can be provided between the photo mask forming the longitudinal electrode pattern and the photo mask for use in the step of forming the gate electrode. Commonality can be provided between the photo mask forming the cross electrode pattern and the photo mask for use in the step of forming the source electrode.

Actually, because the pixel electrode covers the pixel area almost entirely, the island pattern, transverse line pattern, longitudinal line pattern, transverse line pattern, longitudinal line pattern and cross electrode pattern are formed under the pixel electrode. In the reflection liquid crystal display device, however, incident light is reflected in the pixel electrode, and therefore patterns formed under the reflecting electrode do not cause reduction in numerical aperture of the pixel. Thus, degradation of display quality due to reduction in numerical aperture will not occur.

In the area where the transverse line pattern and longitudinal line pattern are superimposed on the pixel electrode, a stray capacitance is formed between the line pattern and the pixel electrode. The stray capacitance between the pixel electrode and the line pattern can be reduced. For this purpose, for example, a thick insulation film may be formed between the line pattern and the pixel electrode. For the insulation film, if a coating type insulation film produced by a spin coating method or the like is formed in thickness of 1 to 4 μm, for example, the stray capacitance can be reduced, thus making it possible to avoid degradation of display quality of the liquid crystal display device associated with stray capacitance.

Furthermore, not merely between two different specifications, commonality of the photo mask can also be provided among three or more different specifications using a similar method.

According to another aspect of the present invention is provided a reflection type liquid crystal display device comprising a pair of substrates, a liquid crystal layer held between the aforementioned pair of substrates, a common signal electrode formed on one of the above described pair of substrates and having transparency, a plurality of scan signal lines formed on the other substrate, a plurality of image signal lines substantially orthogonal to the above-described scan signal lines, thin film transistors formed near the points of intersection of the above described scan signal lines and the above described image signal lines and having semiconductor layers, source electrodes, gate electrodes and drain electrodes, and reflection type pixel electrodes connected to the above described thin film transistor and having a function as a reflecting plate, the reflection type liquid crystal display device further comprising:

an island pattern formed on the same layer as the above described semiconductor layers and forming a matrix pattern having predetermined regularity in cooperation with the above described semiconductor layer, the island pattern being arranged so that the above described matrix pattern has a pitch different from at least one of the pitch of the above described pixel electrode neighboring in the extending direction of the above described image signal line and the pitch of the above described pixel electrode neighboring in the extending direction of the above described scan signal line.

According to the above reflection type liquid crystal display device, any one of the semiconductor layer and the island pattern in the matrix pattern can be selected to form pixel electrodes each having a desired size consistent with the pitch thereof.

In addition, with respect to the scan signal line, image signal line, gate electrode, source electrode, drain electrode or the like, reflection type liquid crystal display devices comprising pixel electrodes having different pitches dependent on regularity can be produced with different specifications.

Also is provided a reflection type liquid crystal display device including a first substrate having a common signal electrode of transparency, a second substrate placed in a position opposite to the first substrate, with a plurality of pixel areas being demarcated in matrix form on the surface opposite to the above described first substrate, and a liquid crystal layer held between the above described first substrate and the above described second substrate, the reflection type liquid crystal display device comprising:

a plurality of pixel electrodes formed on areas substantially same as the above described plurality of pixel areas and having a function as a reflecting plate, thin film transistors formed in matrix form below the above described pixel electrodes and on the above described first substrate, having a pitch smaller than at least one of the traverse pitch and the longitudinal pitch of the above described pixel electrode, and having semiconductor layers, source electrodes, drain electrodes and gate electrodes, image signal lines formed along the row of the above described thin film transistors aligned in the traverse direction, scan signal lines formed along the line of the above described thin film transistors aligned in the longitudinal direction, a layer insulation film formed on the above described first substrate in such a manner as to cover the thin film transistors, with the above described pixel electrodes formed thereon, and through-holes provided in the layer insulation film and exposing the upper faces of the above described source electrodes, each though-hole connecting one of the above described pixel electrodes to one of the above described thin film transistors.

According to the above reflection type liquid crystal display device, a reflection type liquid crystal display device comprising pixel electrodes having any pitch larger than the pitch of the thin film transistor can be produced. For the above structures, commonality of photo masks can be provided for one photo mask when reflection type liquid crystal display devices with different specifications are produced, by applying each one of the structures, but commonality of photo masks can also be provided for a plurality of photo masks by applying these structures in combination.

In the above structure, the pitches of the longitudinal line pattern, the longitudinal electrode pattern provided in the extending direction of the image signal line, the traverse electrode pattern provided in the extending direction of the image signal line, and the island pattern in the extending direction of the image signal line are preferably identical to or smaller than the smallest pitch of pixel electrodes neighboring in the extending direction of the image signal line in the product, for example.

In a similar way, the pitches of the transverse line pattern, the longitudinal electrode pattern provided in the extending direction of the image signal line, the transverse electrode pattern provided in the extending direction of the image signal line, and the island pattern provided in the extending direction of the image signal line should be identical to or smaller than the smallest pitch of pixel electrodes neighboring in the extending direction of the scan signal line in the product.

The reason why commonality of photo masks can be provided will be described below showing the case as an example where a product in which the pitch of pixel electrodes neighboring in the extending direction of the scan signal line is larger than the pitch of the transverse line pattern is produced.

For the step of forming the longitudinal line pattern, the transverse line pattern, the longitudinal electrode pattern, the transverse electrode pattern and the island pattern, commonality of photo masks is provided for all the photo masks to form the above described structure when producing reflection type liquid crystal display devices having different pitches of pixel electrodes. Whether or not the longitudinal line pattern is used as scan signal lines is determined by selectively forming pad electrodes for connection with external driving circuits and through-holes for connecting the pad electrodes to the scan signal lines at terminals of the scan signal lines. The pattern with these items selectively formed constitutes the scanning line pattern.

Similarly, with respect to the transverse line pattern, a determination is made by selectively forming pad electrodes and through-holes at terminals of the line pattern to be used as image signal lines. Here, the longitudinal line pattern and the transverse line pattern selected as the scan signal line and the image signal line varies depending on the pitch of the pixel electrodes of the reflection type liquid crystal display device to be produced. More specifically, the longitudinal line pattern and the transverse line pattern to which thin film transistors to be connected to pixel electrodes are connected are selected as the scan signal line and the image signal line, respectively.

For thin film transistors to be connected to pixel electrode, thin film transistors formed on the areas on which pixel electrodes are each to be placed are used. Here, the thin film transistors are formed at an interval identical to or smaller than the smallest pitch of pixel electrode in the reflection type liquid crystal display device. Therefore, at least one thin film transistor is placed under the pixel electrode, and thus there are no possibilities that the thin film transistor is absent. In the case where two or more thin film transistors are placed, any one of those thin film transistors may be connected. However, for thin film transistors to be connected to pixel electrodes formed in such a manner as to align in the extending direction of the scan signal line (X direction), thin film transistors formed in such a manner as to align in the X direction are more desirably selected. That is because by connecting the thin film transistors formed in such a manner as to align in the X direction to the same scan signal line, conventional driving circuits and driving systems can be used, thus preventing an increase in the number of scan signal lines.

Similarly, with respect to pixel electrodes formed in the extending direction of the image signal line (Y direction), thin film transistors formed in such a manner as to align in the Y direction are desirably selected and connected to pixel electrodes each by each.

For this reason, commonality of photo masks can be provided for the photo masks that are used when products whose pitches of pixel electrodes, substrate outer shapes and sizes of screen display are different from one another are produced.

Furthermore, in the above structure, for thin film transistors that are not used as switching elements, switching operation is carried out if the longitudinal line pattern with the thin film transistor connected thereto is selected as the scan signal line, and image signals are sent if the transverse line pattern with the thin film transistor connected thereto is selected as the image signal lines. However, in any of these cases, the thin film transistor is not connected to the pixel electrode. Therefore, this never brings about a factor that will degrade display properties in terms of optical properties and driving operations, and thus raises no problems.

In the above structure, the position of the pixel electrode relative to the thin film transistor may vary for each pixel electrode. However, even if this relative position varies, it never brings about a factor that will degrade optical properties, display properties, driving properties or the like as properties of the reflection type liquid crystal display device.

In the above structure, the pixel electrodes are superimposed on the island pattern, the transverse line pattern and longitudinal line pattern, the transverse line pattern and the longitudinal line pattern. However, in the reflection type liquid crystal display device, the pattern placed under the pixel electrodes never brings about a factor that will reduce the numerical aperture.

Therefore, degradation of display quality caused by reduction in the numerical aperture will never happen. Also, in the area in which the pixel electrode is superimposed on the transverse line pattern and longitudinal line pattern, stray capacitance is formed between the line patterns and the pixel electrode, but the problem can be avoided by the following methods.

In a first method of avoiding the problem, an insulation film is formed between the pixel electrode and the transverse line pattern and longitudinal line pattern such that the stray capacitance therebetween is not significant. For example, a coating type insulation film is formed in thickness of about 1 to 4 μm by the spin coat method or the like, whereby the capacitance can be reduced, thus making it possible to avoid degradation of display quality associated with stray capacitance.

In a second method, the transverse line pattern not selected as the image signal line and the non selected longitudinal line pattern not selected as the scan signal line are all connected at the sides opposite to the terminals of the image signal line and the scan signal line using, for example, pad electrodes. Then, a fixed voltage, for example voltage as applied to the opposite electrodes is applied to the pad electrodes. Thereby, the stray capacitance can be converted into retention capacity of liquid crystals, thus making it possible to improve display quality.

Other objects, features and advantages of the invention will become apparent from the following description of the embodiments of the invention taken in conjunction with the accompanying drawings.

### BRIEF DESCRIPTION OF THE DRAWINGS

FIGS. 1A and 1B are plan views showing a principle of the present invention in a simplified manner;

FIGS. 2A to 2C are plan views showing the principle of the present invention in a simplified manner;

FIG. 3 is a plan view showing an overall configuration of a reflection type liquid crystal display device according to a first embodiment of the present invention;

FIG. 4 is a plan view of the reflection type liquid crystal display device produced with a first specification according to the first embodiment of the present invention;

FIG. 5 is a plan view of the reflection type liquid crystal display device produced with the first specification according to the first embodiment of the present invention;

FIG. 6 is a sectional view of the reflection type liquid crystal display device produced with the first specification according to the first embodiment of the present invention, taken along a line VI-VI′;

FIG. 7A is a plan view of a terminal for a scan signal line GTM placed in an area D of FIG. 3 in the reflection type liquid crystal display device according to the first embodiment of the present invention, and FIG. 7B is a sectional view taken along a VII-VII′ line of FIG. 7A;

FIG. 8A is a plan view of a terminal for an image signal line DTM placed in an area C of FIG. 3, and FIG. 8B is a sectional view taken along a VIII-VIII′ of FIG. 8A;

FIG. 9 is an equivalent circuit diagram of the reflection type liquid crystal display device (active matrix type liquid crystal display device) according to the first embodiment of the present invention;

FIG. 10 shows a production process for the reflection type liquid crystal display device according to the first embodiment of the present invention;

FIG. 11 is a schematic plan view of a large transparent insulation substrate for use in production of a reflection type liquid crystal display device according to a second embodiment of the present invention, showing a substrate area of the reflection type liquid crystal display device that is used with first and second specifications;

FIG. 12 is a plan view showing a structure of an A area of FIG. 11;

FIG. 13 shows a structure of an area F of FIG. 11 in the reflection type liquid crystal display device according to the second embodiment of the present invention, wherein FIG. 13A is a plan view of a portion of a terminal for a scan signal line, and FIG. 13B is a sectional view taken along a XIII-XIII′ line of FIG. 13A;

FIG. 14 shows the structure of an area C of FIG. 11 in the reflection type liquid crystal display device according to the second embodiment of the present invention, wherein FIG. 14A is a plan view of a portion of a terminal for an image signal line, and FIG. 14B is a sectional view taken along a XIII-XIII′ line of FIG. 13A;

FIG. 15 is a plan view of a transparent insulation substrate on which a thin film transistor is placed in a reflection type liquid crystal display device produced with the first specification, according to a third embodiment of the present invention;

FIG. 16 is a plan view of a transparent insulation substrate on which a thin film transistor is placed in the reflection type liquid crystal display device produced with the second specification, according to the third embodiment of the present invention;

FIG. 17 is plan view of the area in which a terminal for a scan signal line GTM is formed, in the reflection type liquid crystal display device according to the third embodiment of the present invention;

FIG. 18 shows a production process for the reflection type liquid crystal display device according to the third embodiment of the present invention;

FIG. 19 is a plan view showing a configuration on a side opposite to a portion of a terminal for scan signal line of a reflection type liquid crystal display device according to a fourth embodiment of the present invention;

FIGS. 20A to 20F are circuit diagrams showing a configuration on a side opposite to a portion of a terminal for scan signal line of the reflection type liquid crystal display device according to a variation of the fourth embodiment of the present invention;

FIG. 21 is a plan view showing a transparent insulation substrate on which a thin film transistor is placed in a reflection type liquid crystal display device produced with the first specification, according to a fifth embodiment of the present invention;

FIG. 22 is a plan view showing a transparent insulation substrate on which a thin film transistor is placed in a reflection type liquid crystal display device produced with the first specification, according to a sixth embodiment of the present invention;

FIG. 23 is a plan view showing the transparent insulation substrate on which the thin film transistor is placed in the reflection type liquid crystal display device produced with the second specification, according to the sixth embodiment of the present invention;

FIG. 24 is a plan view showing a configuration on a side opposite to a portion of a terminal for an image signal line of the reflection type liquid crystal display device according to the sixth embodiment of the present invention;

FIG. 25 shows a production process for the reflection type liquid crystal display device according to the sixth embodiment of the present invention;

FIG. 26 is a sectional view of a reflection type liquid crystal display device according to a seventh embodiment of the present invention, showing a partial section of the reflection type liquid crystal display device produced with the first specification when commonality of masks is provided for the mask for forming semiconductor layers and image signal lines and concurrently drain electrodes between the first and second specifications;

FIG. 27 is a sectional view of the reflection type liquid crystal display device according to the seventh embodiment of the present invention, showing a partial section of the reflection type liquid crystal display device produced with the first specification when commonality of masks is provided for the mask for forming scan signal electrodes and concurrently gate electrodes, and image signal lines and concurrently drain electrodes between the first and second specifications;

FIG. 28 is a sectional view of the reflection type liquid crystal display device according to the seventh embodiment of the present invention, showing a partial section of the reflection type liquid crystal display device produced with the first specification when commonality of masks is provided for the mask for forming scan signal electrodes and concurrently gate electrodes, and image signal lines and concurrently drain electrodes between the first and second specifications;

FIG. 29 is a plan view of the structure corresponding to FIG. 27, in the case of the reflection type liquid crystal display device produced with the first specification;

FIG. 30 is a plan view when the reflection type liquid crystal display device according to the seventh embodiment of the present invention is produced with the second specification;

FIG. 31 is a partial sectional view of the reflection type liquid crystal display device according to the eighth embodiment of the present invention produced with the first specification when commonality of masks is provided for the mask for use in formation of the scan signal line and concurrently gate line, the semiconductor layer SI1, and the image signal line and concurrently drain electrode with the first specification and the second specification;

FIG. 32 is a schematic plan view of a large transparent insulation substrate for use in production of a reflection type liquid crystal display device according to an eighth embodiment of the present invention;

FIG. 33 is a plan view of an area G surrounded in FIG. 32;

FIG. 34 is a plan view of a transparent insulation substrate SUB1 on which a thin film transistor TFT is formed when the reflection type liquid crystal display device according to the eighth embodiment of the present invention is produced with the first specification;

FIG. 35 is a plan view of the transparent insulation substrate SUB1 on which the thin film transistor TFT is formed when the reflection type liquid crystal display device according to the eighth embodiment of the present invention is produced with the second specification;

FIG. 36 is a sectional view of the reflection type liquid crystal display device produced with the first specification, taken along a 36-36′ line shown in FIG. 34;

FIG. 37A is a plan view of a portion of a terminal for a scan signal line GTM in the reflection type liquid crystal display device according to the eighth embodiment of the present invention, and FIG. 37B is a sectional view taken along 37a-37a′ in FIG. 37A;

FIG. 38A is a plan view of a portion of a terminal for an image signal line DTM in the reflection type liquid crystal display device according to the eighth embodiment of the present invention, and FIG. 38B is a sectional view taken along 38a-38a′ in FIG. 38A; and

FIG. 39 shows a production process for the reflection type liquid crystal display device according to the eighth embodiment of the present invention.

### PREFERRED EMBODIMENTS OF THE INVENTION

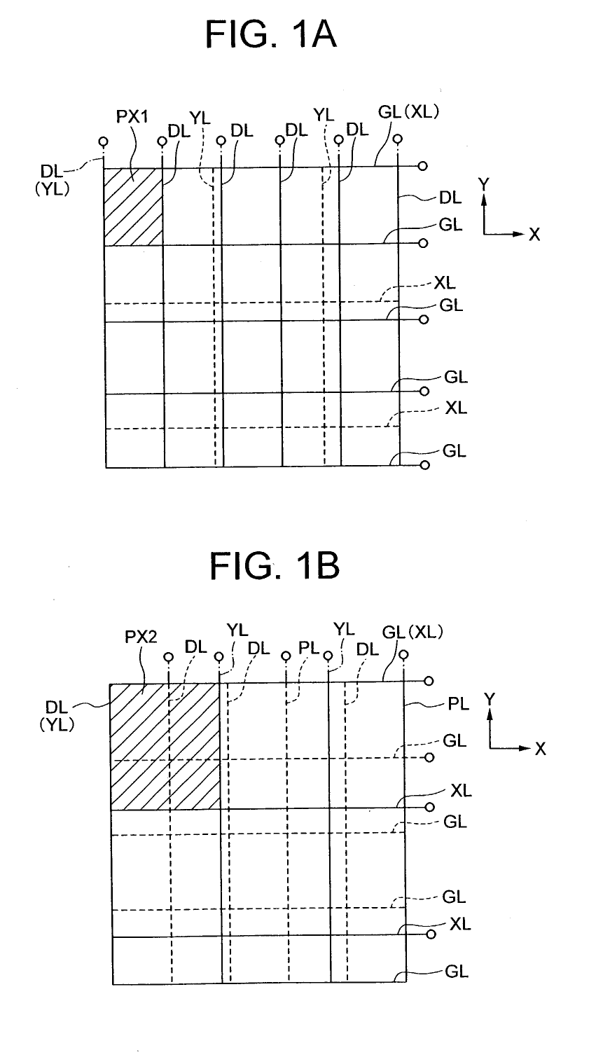

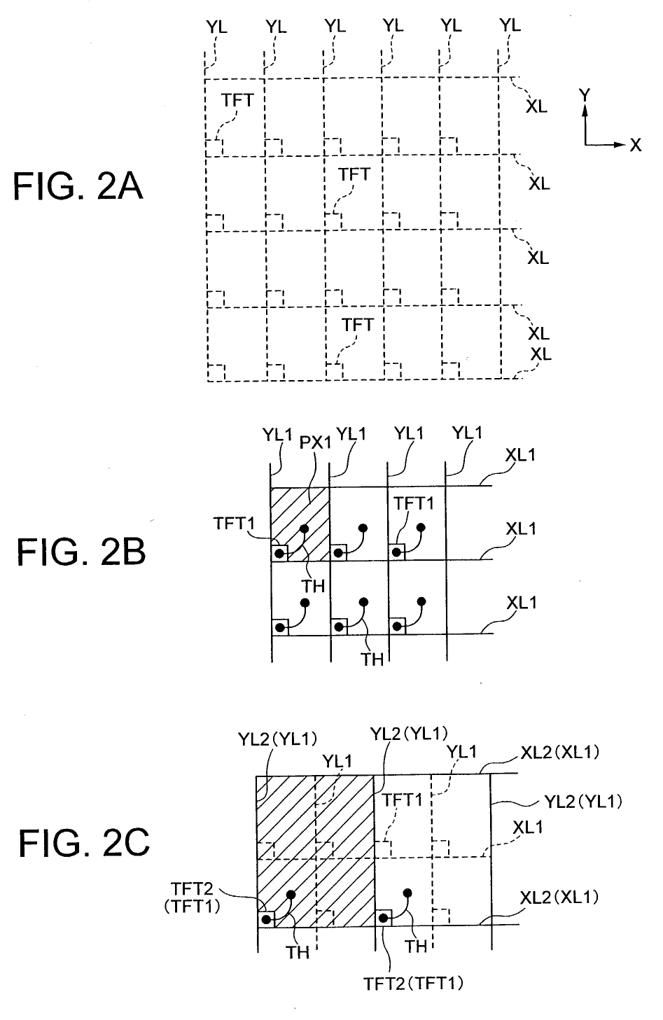

The principle of the present invention devised by the inventor will be discussed referring to FIGS. 1 and 2.

FIG. 1A is a simplified plan view of a reflection type liquid crystal display device produced with a first specification. FIG. 1B is a simplified plan view of a reflection type liquid crystal display device produced with a second specification.

As described in FIGS. 1A and 1B, a plurality of image signal lines DL extending in the Y direction and aligned at a first pitch in the X direction, and a transverse line pattern YL formed in parallel thereto and aligned at a third pitch in the X direction are formed on a substrate in which a two-dimensional X-Y plane including X and Y axes diagonal to each other is demarcated. Furthermore, FIGS. 1A and 1B show the case where the image signal line is identical to the transverse line pattern for the leftmost pattern in these drawings.

In addition, on the substrate, a plurality of scan signal lines GL extending in the X direction and aligned at a second pitch in the Y direction, and a longitudinal line pattern XL formed in parallel thereto and aligned at a fourth pitch in the Y direction are formed. Furthermore, FIGS. 1A and 1B show the case where the scan signal line is identical to the longitudinal line pattern for the uppermost pattern In these drawings.

As shown in FIG. 1A, in the first specification, pixel electrodes PX1 are formed at a first pitch in the X direction, and at a second pitch in the Y direction. The area shown by right-down slanting lines represents one pixel area, and the pixel electrode PX1 is formed substantially in the same area as the pixel area. The lines provided between pixel electrodes PX1 neighboring in the X and Y directions function as the image signal lines DL and the scan signal lines GL, respectively, in the first specification. These lines are connected to external drive circuits (peripheral circuits) such as an image signal line driving circuits and a scan signal line driving circuit (not shown). The line pattern YL not identical to the image signal line DL and the longitudinal line pattern XL not identical to the scan signal line GL do not function in the reflection type liquid crystal display device produced with the first specification.

As shown in FIG. 1B, in the second specification, pixel electrodes PX2 are formed at a second pitch in the X direction, and at a fourth pitch in the Y direction. The area given slanting lines represents a pixel area, and the pixel electrode PX2 is formed substantially in the same area as the pixel area. The lines YL and XL (FIG. 1A) provided between the pixel electrodes PX2 neighboring in the X and Y directions function as the image signal line and the scan signal line, respectively, in the second specification. These lines are connected to the image signal line driving circuit and scan signal line driving circuit (not shown). The line pattern DL not identical to the image signal line YL and the longitudinal line pattern GL not identical to the scan signal line XL do not function in the reflection type liquid crystal display device produced with the second specification.

More specifically, in the first specification, gate electrodes, semiconductor layers, drain electrodes, and source electrodes of thin film transistors, and scan signal lines and image signal lines are formed in the display area on the substrate on which the thin film transistors are formed. At this time, invalid patterns independent of the display function provided in the first specification and not connected to the external driving circuit are formed. These invalid patterns are at least one of an island pattern, transverse line pattern, longitudinal line pattern, transverse electrode pattern, longitudinal electrode pattern and cross electrode pattern. These invalid patterns do not practically function in the case of the reflection type liquid crystal display device produced with the first specification.

The reflection type liquid crystal display device produced with the second specification, whose pitch of pixel electrodes is different from that of pixel electrodes in the reflection type liquid crystal display device produced with the first specification, is designed so that these invalid patterns function as valid patterns. Specifically, the island pattern, transverse line pattern, longitudinal line pattern, transverse electrode pattern, longitudinal electrode pattern and cross electrode pattern formed in the reflection type liquid crystal display device produced with the first specification function as the semiconductor layer of the thin film transistor, the image signal line, the scan signal line, the drain electrode, the gate electrode and the source electrode, respectively in the reflection type liquid crystal display device with the second specification.

If the reflection type liquid crystal display device is produced with the second specification, the patterns that function as the semiconductor layer of the thin film transistor, the image signal line, the scan signal line, the drain electrode and the gate electrode formed in the first specification are equivalent to the island pattern, transverse line pattern, longitudinal line pattern, longitudinal electrode pattern, transverse electrode pattern and cross electrode pattern, respectively, which have practically no functions as elements of the pixel in the second specification.

As long as the reference positions for the first and second specifications are the same, patterns placed in the positions corresponding to common multiples of the pitch of respective pixel electrodes in each specification function as the semiconductor layer, the image signal line, the scan signal line, the drain electrode, the gate electrode and the source electrode in either the first or second specification.

By using the above technique, commonality of photo masks can be provided as described below, for example, for the first and second specifications.

Fist, commonality can be provided between the photo mask for forming an island pattern and the photo mask for use in the step of producing the semiconductor layer of the thin film transistor. Commonality can be provided between the photo mask forming the transverse line pattern and the photo mask for use in the step of forming the image signal line. Commonality can be provided between the photo mask forming the transverse electrode pattern and the photo mask for use in formation of the gate electrode. Commonality can be provided between the photo mask forming the longitudinal line pattern and the photo mask for use in the step of forming the scan signal line. Commonality can be provided between the photo mask forming the longitudinal electrode pattern and the photo mask for use in the step of forming the source electrode. Commonality can be provided between the photo mask forming the cross electrode pattern and the photo mask for use in the step of forming the source electrode.

Furthermore, in fact, the scan signal line and the gate electrode and transverse electrode pattern are often formed in the same step, and the image signal line, the source and drain electrodes, the longitudinal electrode pattern and the cross electrode pattern are generally produced in the same step.

The reflection type pixel electrode covers almost entirely a pixel area demarcating the area of one pixel, and is therefore superimposed on the island pattern, transverse line pattern, longitudinal line pattern, transverse line pattern, longitudinal line pattern and cross electrode pattern. In the reflection type liquid crystal display device, however, incident light is reflected in the pixel electrode as described above, and therefore patterns formed under the reflecting electrode do not cause reduction in numerical aperture of the pixel. Thus, degradation of display quality due to reduction in numerical aperture will not occur.

Furthermore, the photo mask has so called an alignment mark defining the reference position for alignment of masks between production steps. The above invalid patterns are different from the alignment mark, and function in a different way.

For example, the following configuration has been devised as an alternative method for providing commonality between masks when the substrate outer shape, the size of display screen and the pitch of pixel electrodes are changed.

The principle of the alternative method will be described below referring to FIGS. 2A to 2C. Furthermore, the principle described below is simplified for clarified explanation.

FIG. 2A is a simplified plan view of a reflection type liquid crystal display device produced in a partway with a part of specification in common with the first and second specifications. FIG. 2B is a simplified plan view of a reflection type liquid crystal display device produced with the first specification subsequent to the state shown in FIG. 2A. FIG. 2C is a simplified plan view of a reflection type liquid crystal display device produced with the second specification subsequent to the state shown in FIG. 2A.

As shown in FIG. 2A, a plurality of transverse lines YL extending in the Y direction and aligned at a first pitch in the X direction, a plurality of longitudinal lines XL extending in the X direction and aligned at a second pitch in the Y direction, and thin film transistors TFT formed near the points of intersection between the transverse lines YL and the longitudinal lines XL are provided on a substrate demarcating a two-dimensional X-Y plane including X and Y axes diagonal to each other.

Any one of structures of FIG. 2B and FIG. 2C can be selected subsequent to the structure shown in FIG. 2A to produce the reflection type liquid crystal display device.

In the first specification shown in FIG. 2B, for example, all the transverse lines YL and all the longitudinal lines XL are used as image signal lines and scan signal lines, respectively. The pixel area given slanting lines (pixel electrode PX1) is formed on every area surrounded by the transverse line YL and the longitudinal line XL. The thin film transistors TFT (source electrodes of TFT in the strict sense) formed at all the points of intersection between the transverse lines YL and the longitudinal lines XL are each electrically connected to the pixel electrode via a through-hole TH. In the structure shown in FIG. 2B, the pixel electrodes PX1 are aligned at a first pitch in the X direction, and at a second pitch in the Y direction.

In the second specification shown in FIG. 2C, for example, transverse lines XL2 selected from the transverse lines YL shown in FIG. 2A and longitudinal lines YL2 selected from the longitudinal lines XL are used as image signal lines and scan signal lines, respectively. The pixel area given slanting lines (pixel electrode PX2) is formed on every area surrounded by the transverse line YL2 and the longitudinal line XL2. The thin film transistors TFT (source electrodes of TFT in the strict sense) formed at all the points of intersection between the transverse lines YL2 and the longitudinal lines XL2 are each electrically connected to the pixel electrode via a through-hole TH.

In the structure shown in FIG. 2C, the pixel electrodes PX2 are aligned at a third pitch different from the first pitch in the X direction, and at a fourth pitch different from the second pitch in the Y direction. Furthermore, in the above example, all the longitudinal lines and transverse lines are selected in the first specification, and longitudinal lines and transverse lines having pitches larger than those of the first specification by a factor of some integer number (by a factor of 2) in the X and Y directions are selected in the second specification, but if they are equal to common multiples of the first and second pitches of FIG. 2A, respectively, longitudinal lines and transverse lines can optionally be selected depending on whether or not through-holes TH are formed.

Based on the above philosophy, commonality of photo masks can be provided for one photo mask when reflection type liquid crystal display devices with different specifications are produced, but commonality of photo masks can be provided for a plurality of photo masks by using photo masks in combination.

For example, the pitches of the longitudinal line pattern, the longitudinal electrode pattern provided in the extending direction of the image signal line, the transverse electrode pattern provided in the extending direction of the image signal line and the island pattern provided in the extending direction of the image signal line are identical to or smaller than the smallest pitch of pixel electrodes neighboring in the extending direction of the image signal line in the product.

In a similar way, the pitches of the transverse line pattern, the longitudinal electrode pattern provided in the extending direction of the image signal line, the transverse electrode pattern provided in the extending direction of the image signal line and the island pattern provided in the extending direction of the image signal line are identical to or smaller than the smallest pitch of pixel electrodes neighboring in the extending direction of the scan signal line in the product, for example.

The reason why commonality of photo masks can be provided will be described below showing the case as an example where a product in which the pitch of pixel electrodes neighboring in the extending direction of the scan signal line is larger than the pitch of the transverse line pattern is produced.

With respect to the steps of forming the scan signal line and the longitudinal line pattern, the image signal line and the transverse line pattern, the source and drain electrodes and the longitudinal electrode pattern, the gate electrode and transverse electrode pattern, and the semiconductor layer (active layer) and the island pattern, commonality of photo masks is provided for all photo masks to form the above structure when producing two reflection type liquid crystal display devices having different pitches of pixel electrodes. Whether or not the stripe pattern including the longitudinal line pattern and scan signal lines actually functions as scan signal lines for transmitting scan signals is determined by selectively forming pad electrodes for connection to external driving circuits, and through-holes for connecting the pad electrodes to scan signal lines at terminals of the lines. The pattern with these items formed selectively constitutes an actual scanning line pattern.

In a similar way, with respect to the image signal line and the transverse line pattern, pad electrodes and through-holes are selectively formed at the terminals of the line pattern for uses as image signal lines. Here, the lines selected as scan signal lines and image signal lines may be adapted to match with the pitch of pixel electrodes of the reflection type liquid crystal display device to be produced. More specifically, lines to which thin film transistors to be connected pixel electrodes are connected are selected as scan signal lines and image signal lines, respectively.

For thin film transistors to be connected to pixel electrode, thin film transistors formed on the areas on which pixel electrodes are each to be placed are used. Here, the thin film transistors are formed at an interval identical to or smaller than the smallest pitch of pixel electrodes in the reflection type liquid crystal display device. Therefore, at least one thin film transistor is placed under the pixel electrode, and thus there are no possibilities that the thin film transistor is absent. In the case where two or more thin film transistors are placed, any one of those thin film transistors may be connected. However, for thin film transistors to be connected to pixel electrodes formed in such a manner as to align in the extending direction of the scan signal line (X direction), a column of thin film transistors formed in such a manner as to align in the X direction is more desirably selected. That is because by connecting the thin film transistors formed in such a manner as to align in the X direction to the same scan signal line, conventional driving circuits and driving systems can be used, thus preventing an increase in the number of scan signal lines.

Similarly, with respect to pixel electrodes formed in the extending direction of the image signal line (Y direction), a row of thin film transistors formed in such a manner as to align in the Y direction are desirably selected and connected to pixel electrodes each by each.

By using the above technique, commonality of photo masks can be provided for the photo masks that are used when products whose pitches of pixel electrodes, substrate outer shapes and sizes of screen display are different from one another are produced.

Furthermore, in the above structure, for thin film transistors that are not used as switching elements, switching operation is carried out if the longitudinal line pattern with the thin film transistor connected thereto is selected as the scan signal line, and image signals are sent if the transverse line pattern with the thin film transistor connected thereto is selected as the image signal lines. However, in any of these cases, the thin film transistor is not connected to the pixel electrode. Therefore, this never brings about a factor that will degrade display properties in terms of optical properties and driving operations, and thus raises no problems.

In the above structure, the position of the pixel electrode relative to the thin film transistor may vary for each pixel electrode. However, even if this relative position varies, it never brings about a factor that will degrade optical properties, display properties, driving properties or the like as properties of the reflection type liquid crystal display device.

Also, in the above structure, the pixel electrodes are superimposed on the island pattern, the transverse line pattern and longitudinal line pattern, the transverse line pattern and the longitudinal line pattern. However, in the reflection type liquid crystal display device, the pattern placed under the pixel electrodes never brings about a factor that will reduce the numerical aperture, as described above. Therefore, degradation of display quality caused by reduction in the numerical aperture will never happen. Also, in the area in which the pixel electrode is superimposed on the transverse line pattern and longitudinal line pattern, stray capacitance is formed between the line patterns and the pixel electrode, but the problem can be avoided by the aforesaid first and second methods.

Each embodiment of the present invention will be described below based on the above discussion, referring to the drawings.

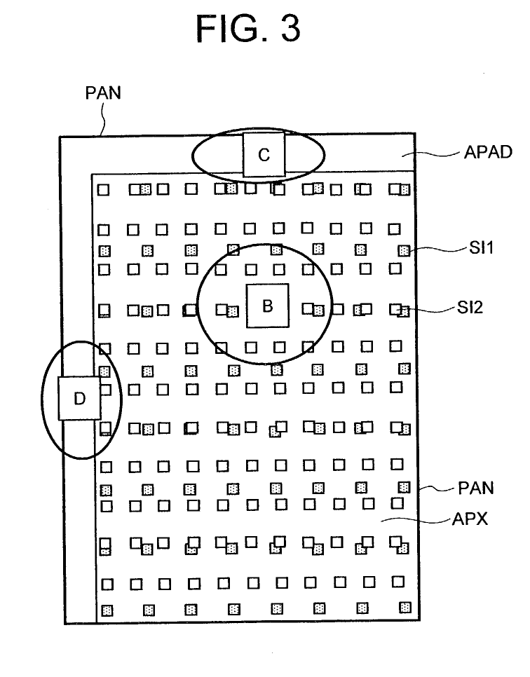

First, the reflection type liquid crystal display device of the first embodiment of the present invention will be described referring to FIGS. 3 to 10. The reflection type liquid crystal display device of the first embodiment is a device in which commonality of photo masks is provided for the photo masks that are used in the step of forming semiconductor layers between the first and second specifications different in pitch of pixel electrodes and identical in substrate outer shape and size of display screen. FIG. 3 is a schematic plan view showing the structure of a TFT substrate of the reflection type liquid crystal display device of the first embodiment of the present invention.

As shown in FIG. 3, the symbol PAN denotes the substrate outer shape (outer outline of the liquid crystal panel) of a reflection type liquid crystal display device A. In the TFT substrate on which the reflection type liquid crystal display device A is formed, a terminal formation area APAD that is an area for connection to external circuits for inputting signals in the terminal for image signal lines and terminal for scan signal lines is provided in the upper and left areas in the view of the TFT substrate. An area other than the terminal formation area APAD is a display area APX. Island patterns SI1 and SI2 described later are formed at least on the display area APX.

A part of the display area (an area shown by symbol B in FIG. 3) and the upper area C and left area D of the terminal formation area APAD in the view will be described below.

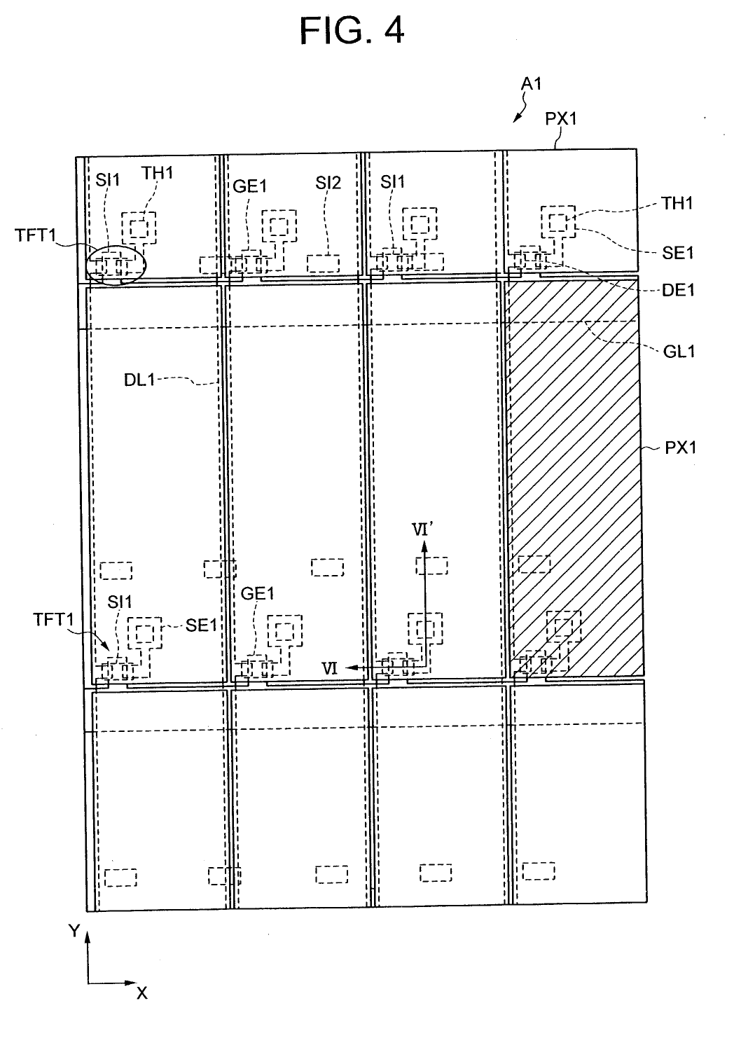

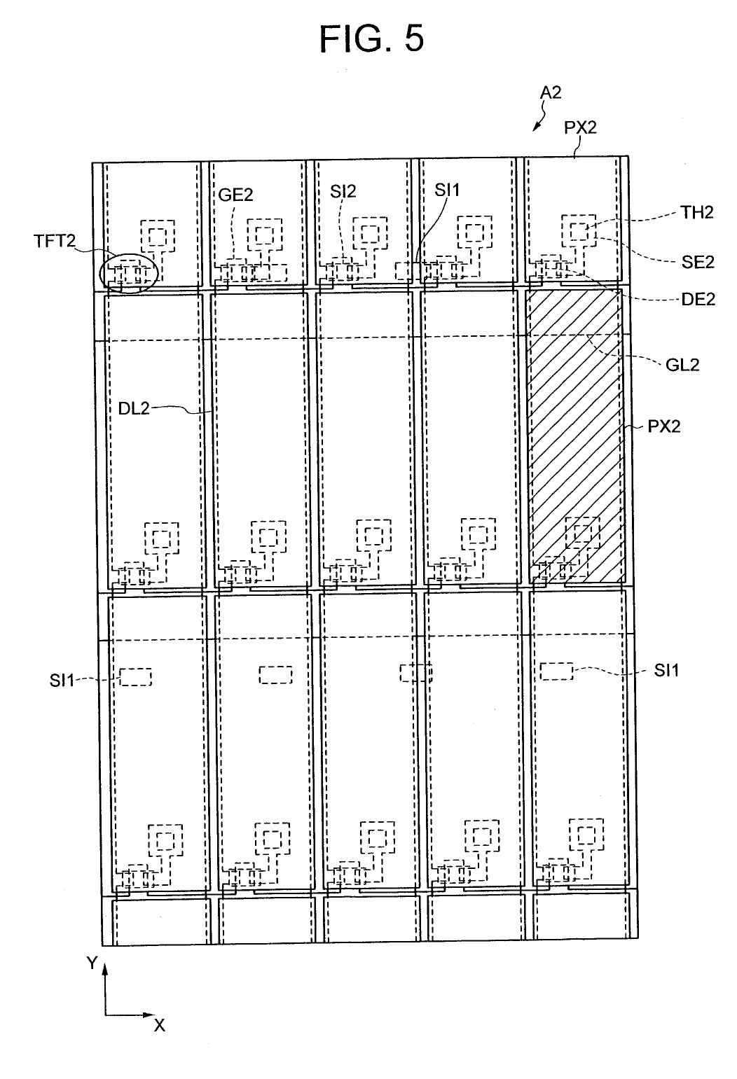

FIG. 4, which shows the structure in the area B of FIG. 3, is a plan view of the reflection type liquid crystal display device produced with the first specification. FIG. 5 is a plan view of the reflection type liquid crystal display device produced with the second specification, also showing the structure in the area B of FIG. 3.

As shown in FIG. 4, the reflection type liquid crystal display device A1 produced with the first specification comprises thin film transistors TFT1, image signal lines DL1 and scan signal lines GL1. In addition, the reflection type liquid crystal display device A comprises through-holes TH1 and pixel electrodes PX1. For the purpose of clarification of areas of pixel electrodes PX1, one of the pixel electrodes PX1 is shown using right-up slanting lines. In addition, island patterns SI1 And SI2 are formed on the substrate, and of the island patterns SI1 and SI2, the island pattern SI1 forms the active area (semiconductor layer) of the thin film transistor TFT1. In addition, the thin film transistor TFT1 comprises a drain electrode DE1, source electrode SE1 and gate electrode GE1.

The reflection type liquid crystal display device A produced with the first specification comprises pixel electrodes PX having a first pitch in the X direction and a third pitch in the Y direction (hereinafter referred to as first-third pitch) on a transparent insulation substrate SUB 1 on which a two-dimensional plane (X-Y plane) is demarcated.

FIG. 5 is a plan view showing the structure of the TFT substrate when the reflection type liquid crystal display device of the first embodiment of the present invention is produced with a second specification different from the first specification. The reflection type liquid crystal display device A2 produced with the second specification comprises thin film transistors TFT2, image signal lines DL2 and scan signal lines GL2. In addition, the reflection type liquid crystal display device A2 comprises through-holes TH2 and pixel electrodes PX2. For the purpose of clarification of areas of pixel electrodes PX2, one of the pixel electrodes PX2 is shown using right-up slanting lines. In addition, island patterns SI1 And SI2 are formed on the substrate, and of the island patterns SI1 and SI2, the island pattern SI2 forms the active area (semiconductor layer) of the thin film transistor TFT2. In addition, the thin film transistor TFT2 comprises a drain electrode DE2, source electrode SE2 and gate electrode GE2.

The reflection type liquid crystal display device A2 produced with the second specification comprises pixel electrodes PX having a second pitch different from the first pitch in the X direction and a fourth pitch different from the third pitch in the Y direction (hereinafter referred to as second-fourth pitch) on a transparent insulation substrate SUB 1 on which a two-dimensional plane (X-Y plane) is demarcated.

As shown in FIGS. 4 and 5, in the above reflection type liquid crystal display device of the first embodiment of the present invention, any one of the thin film transistors TFT1 and TFT2, and any one of the pixel electrodes PX1 and PX2 are formed in the pixel area demarcated by the scan signal line GL1 or GL2 and the image signal line DL1 or DL2, thereby forming one pixel. Furthermore, the thin film transistor TFT is electrically connected to the pixel electrode PX1 or PX2 via the though-hole TH1 or TH2 provided in a surface protection film deposited on the thin film transistor TFT.

In the reflection type liquid crystal display device A1 produced with the first specification, according to the first embodiment of the present invention, the pitch of the island pattern SI1 formed in such a manner as to align in the extending direction of the scan signal line GL1 (X direction) is almost same as that of pixel electrodes PX1 neighboring in the extending direction of the scan signal line GL1 (X direction). The pitch of the island pattern SI1 formed in such a manner as to align in the extending direction of the image signal line DL1 (Y direction) is almost same as that of pixel electrodes PX1 in the first specification, which are neighboring in the extending direction of the image signal line DL1 (Y direction).

On the other hand, in the reflection type liquid crystal display device A2 produced with the second specification, the pitch of the island pattern SI2 formed in such a manner as to align in the extending direction of the scan signal line GL2 (X direction) is almost same as that of pixel electrodes PX2 in the second specification, which are neighboring in the extending direction of the scan signal line GL2, and the pitch of the island pattern SI2 formed in such a manner as to align in the extending direction of the image signal line DL2 (Y direction) is almost same as that of pixel electrodes PX2 in the second specification, which are neighboring in the extending direction of the image signal line DL2 (Y direction).

As shown in FIG. 4, in the reflection type liquid crystal display device A1 produced with the first specification according to the first embodiment of the present invention, the semiconductor layer SI1 is used for the thin film transistor TFT1, and the island pattern SI2 placed with regularity different from that of the semiconductor layer SI1 is an unused pattern. On the other hand, in the case of the reflection type liquid crystal display device produced with the second specification, the island pattern SI2 in the first specification is used as the semiconductor layer of the thin film transistor TFT2 in the second specification as shown in FIG. 5, and the semiconductor layer SI1 in the first specification is an unused pattern in the second specification.

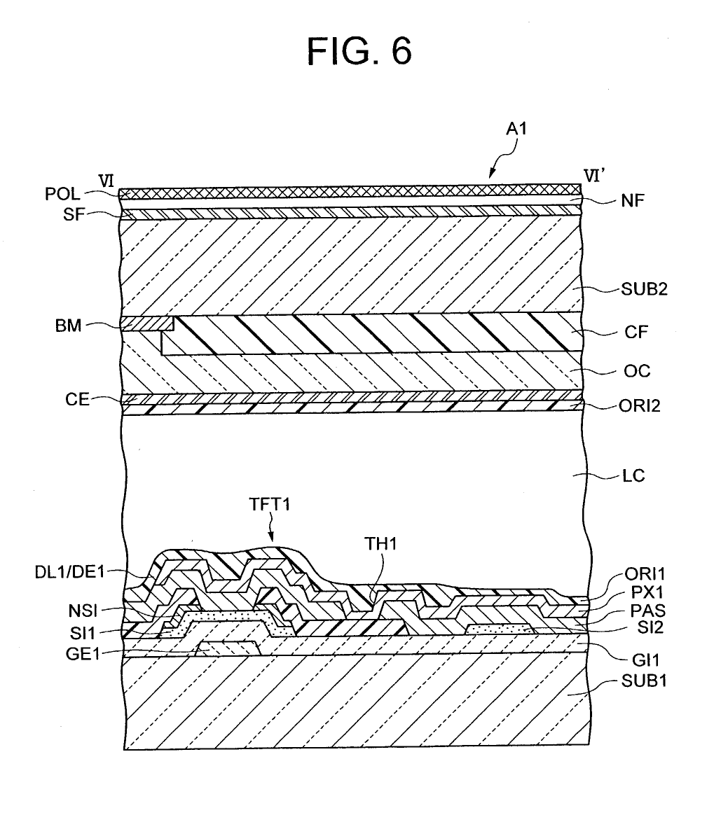

FIG. 6 is a sectional view of the reflection type liquid crystal display device A1 produced with the first specification, taken along the VI-VI′ line shown in FIG. 4.

Furthermore, reference symbol POL denotes a polarizing plate, reference symbol NF denotes a phase contrast plate, reference symbol SF denotes a scattering film, reference symbol SUB2 denotes a transparent insulation substrate with a color filter placed nearby, reference symbol BM denotes a baffle pattern, reference symbol CF denotes a color filter, reference symbol OC denotes an overcoat film, reference symbol CED denotes a common electrode, reference symbols ORI1 and ORI2 denote an orientation film, reference symbol LC denotes a liquid crystal layer, reference symbol PAS denotes the surface protection film of the thin film transistor, reference symbol NSI denotes an electrode composed of silicon doped with phosphorous or the like, reference symbol GI denotes a gate insulation film, reference symbol SUB1 denotes a transparent insulation substrate with the thin film transistor placed nearby, reference symbol DTM denotes the terminal portion of the image signal line, reference symbol PAD denotes a pad electrode for connection to external driving circuits, and reference symbol GTM denotes the terminal portions of the scan signal line.

As shown in FIG. 6, the transparent insulation substrate SUB1 with thin film transistors placed nearby is called a TFT substrate, and the transparent insulation substrate SUB2 located opposite to this TFT substrate SUB1 through the liquid crystal layer LC is called a CF substrate.

In the CF substrate SUB2 of the reflection type liquid crystal display device A1 according to the first embodiment of the present invention, the baffle pattern BM covering gap areas of pixel electrodes on the TFT and demarcating each pixel area is formed on the face contacting the liquid crystal layer LC. The color filter CF is formed in the opening of the baffle pattern BM demarcating substantial pixel areas. In addition, the overcoat film OC composed of, for example, resin film is formed in such a manner as to cover the baffle pattern BM and the color filter CF. The common signal electrode CE is formed on the surface (lower surface) of this overcoat film OC. The orientation film ORI2 is formed on the surface (lower surface) of this common signal electrode CE. The polarizing plate POL, the phase contrast plate NF for compensating for reflectivity anisotropic dispersion of the liquid crystal layer LC, and the scattering film SF for diffusing outgoing light are formed on the upper surface of the DF substrate opposite to the liquid crystal layer LC side.

On the other hand, the thin film transistor TFT of anti-stagger is formed on the side of the TFT substrate SUB1. In the thin film transistor TFT1, when voltage greater than or equal to the threshold for the thin film transistor TFT1 is applied to the scan signal line GL1, the semiconductor layer SI1 is brought into conduction, thus providing continuity between the drain electrode DE1 and the source electrode SE1 of the thin film transistor TFT1. At this time, voltage with its magnitude almost equal to that of voltage applied to the image signal line DL1 is also applied to the pixel electrode PX1.

When the voltage applied to the scan signal line GL1 is below the threshold voltage for the thin film transistor TFT1, isolation is provided between the drain electrode DE1 and the source electrode SE1 of the thin film transistor TFT1. The voltage applied to the image signal line DL1 is not transferred to the pixel electrode PX1. However, the pixel electrode PX1 holds an electric potential transferred thereto when continuity was maintained between the drain electrode DE and the source electrode SE until a next scanning period by a stray capacitance formed between the pixel electrode PX1 and the common electrode CE.

Furthermore, as shown in FIG. 6, the electrode NS1 may be formed by a silicon film doped with impurities such as phosphorous between the drain electrode DE1 and source electrode SE1 and the silicon layer SI1.

The through-hole TH1 is provided in the surface protection film (layer insulation film) PAS of the thin film transistor TFT1 for connecting the source electrode SE1 of the thin film transistor TFT1 to the pixel electrode PX1. The pixel electrode PX1 gets over a step height of the through-hole TH1, and is electrically connected to the upper surface of the source electrode SE1 exposed at the lower portion of the through-hole TH1. The pixel electrode PX1 has a function to reflect light incident from the polarizing plate POL, and this reflected light is used to provide display. The orientation films ORI1 and ORI2 are made to exhibit a function to orientate liquid crystal molecules in the liquid crystal layer LC in a fixed direction by treating the surfaces of the orientation films using a rubbing method or the like.

The polarizing plate POL has a function to convert the light let in the reflection type liquid crystal display device A1 directly into polarized light. The light incident from the polarizing plate POL passes through the phase contrast plate NF and the liquid crystal layer LC, and is then reflected at the pixel electrode PX1. The reflected light passes again through the liquid crystal layer LC and the phase contrast plate NF to reach the polarizing plate POL. The liquid crystal layer LC and the phase contrast plate NF have reflectivity anisotropy. The reflectivity anisotropy of the liquid crystal layer LC changes in its property depending on the electric field applied to the liquid crystal layer LC.

For example, in the case of the reflection type liquid crystal display device of normally white type providing white display with no electric field applied to the liquid crystal layer LC, if an electric field is applied to the liquid crystal layer LC, the light passing through the polarizing plate POL, reflected at the pixel electrode PX1 and reaching the polarizing plate POL again is converted into polarized light parallel to the absorption axis of the polarizing plate POL by the phase contrast plate BF and the liquid crystal layer LC, and is then absorbed by the polarizing plate POL. Thus, the reflected light is never let out to the outside from the reflection type liquid crystal display device A1, and therefore black display is provided.

On the other hand, in the situation in which no electric field is applied to the liquid crystal layer LC, the light reflected at the pixel electrode PX1 and reaching the polarizing plate POL is converted into polarized light vertical to the absorption axis of the polarizing plate POL by the phase contrast plate NF and the liquid crystal layer LC, and is not absorbed by the polarizing plate POL. Therefore, the reflected light is let out to the outside of the reflection type liquid crystal display device A1, and thus white display is provided.

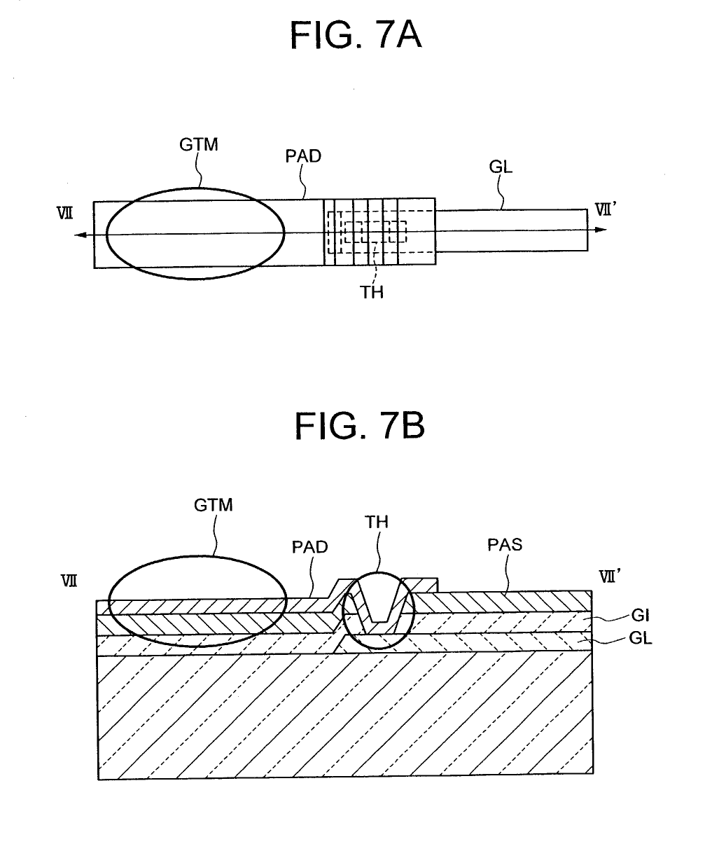

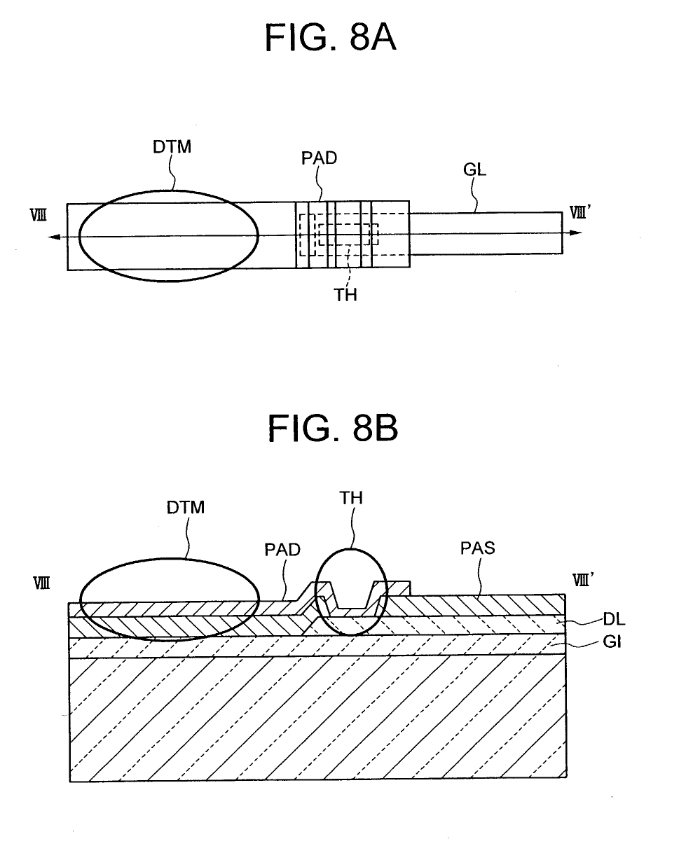

FIG. 7A is a plan view of the terminal for the scan signal line GTM placed in the area D of FIG. 3 in the reflection type liquid crystal display device according to the first embodiment of the present invention, and FIG. 7B shows a sectional view taken along the VII-VII′ of FIG. 7A. FIG. 8A is a plan view of the terminal for the image signal line DTM placed in the area C of FIG. 3, and FIG. 8B is a sectional view taken along the VIII-VIII′ of FIG. 8A.

As shown in FIGS. 7A and 7B, the terminal for the scan signal line GTM has an extending portion of the scan signal line GL provided in an area forming the scan signal terminal portion on the transparent insulation substrate SUB1. In addition, the gate insulation film GI and the surface protection film PAS for the thin film transistor TFT1 are deposited one after another in such a manner as to cover the scan signal line GL, and a part of the extending portion of the scan signal line GL is exposed by the through-hole TH provided in the gate insulation film GI and surface protection film PAS. The pad electrode PAD is formed thereon, thus forming the terminal for the scan signal line GTM. The pad electrode PAD is electrically connected to the scan signal line GL through the through-hole TH.

As shown in FIGS. 8A and 8B, for the terminal for the image signal line DTM, the gate insulation film GI is formed on the transparent insulation substrate SUB1, and the extending portion of the image signal line DL is formed in the area in which the terminal for the image signal line DTM is formed. Thereafter, the surface protection film PAS to cover the thin film transistor TFT is formed, and the through-hole TH is provided in a part of the area in which the pad electrode PAD to be produced in a subsequent step is formed, of the area in which the terminal for the image signal line DTM is formed. The pad electrode PAD is formed thereon, thus forming the terminal for the image signal line DTM. This pad electrode PAD is electrically connected to the image signal line DL through the through-hole TH.

The shape of the terminal portion connected to the electric circuit and external driving circuit of the reflection type liquid crystal display device according to the first embodiment of the present invention will now be described.

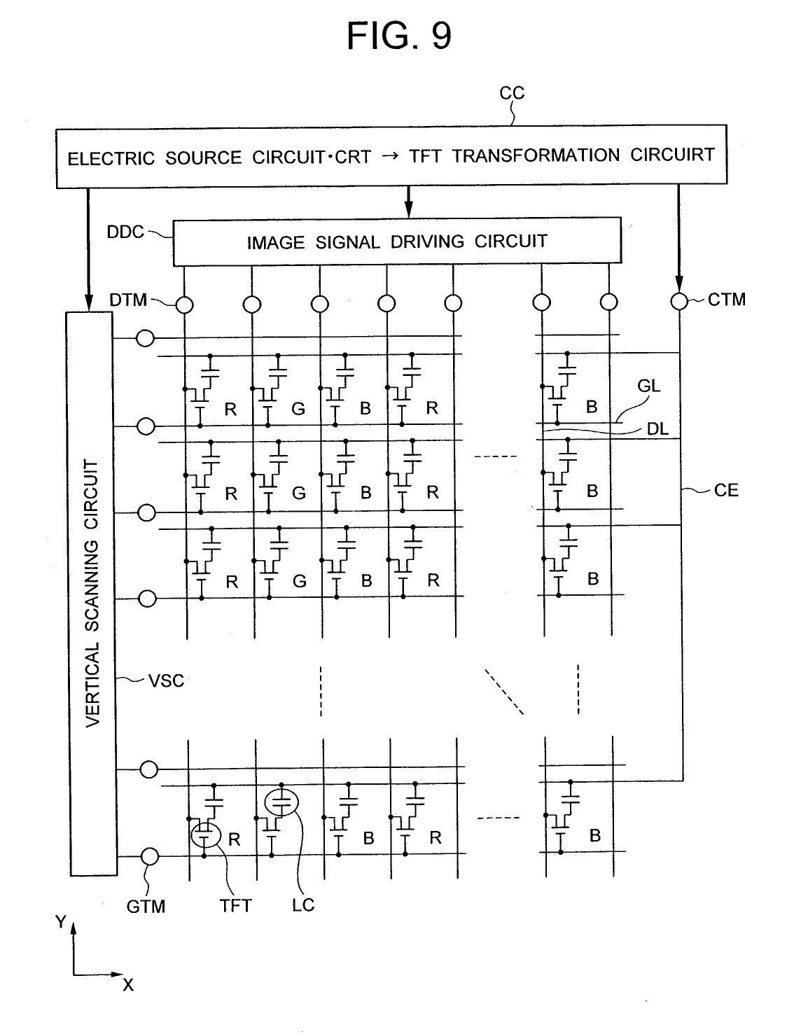

FIG. 9 is a diagram of an equivalent circuit of an active matrix type liquid crystal display device according to the first embodiment of the present invention. As shown in FIG. 9, each scan signal line GL extending in the X direction and aligned in the Y direction is supplied with scan signals (voltage signals) one after another through the terminal for the scan signal line GTM by a vertical scan circuit VSC.

The thin film transistor TFT in each pixel area placed along the scan signal line GL is driven by scan signals. Image signals are supplied to each image signal line DL extending in the Y direction and aligned in the X direction through the terminal for the image signal line DTM from an image signal driving circuit DDC in timing with scan signals. These image signals are transferred to the pixel electrode PX through the thin film transistor TFT in each pixel area. Opposite voltage is applied to the common signal electrode CE through a terminal for the line for common signals CTM, thereby generating an electric field between the pixel electrode PX and the common signal electrode CE. The light transmittance of the liquid crystal layer is controlled with this electric field.

In FIG. 9, symbols R, G and B provided for respective pixel areas indicate a filter for red color, a filter for green color and a filter for blue color formed in those pixel areas, respectively.

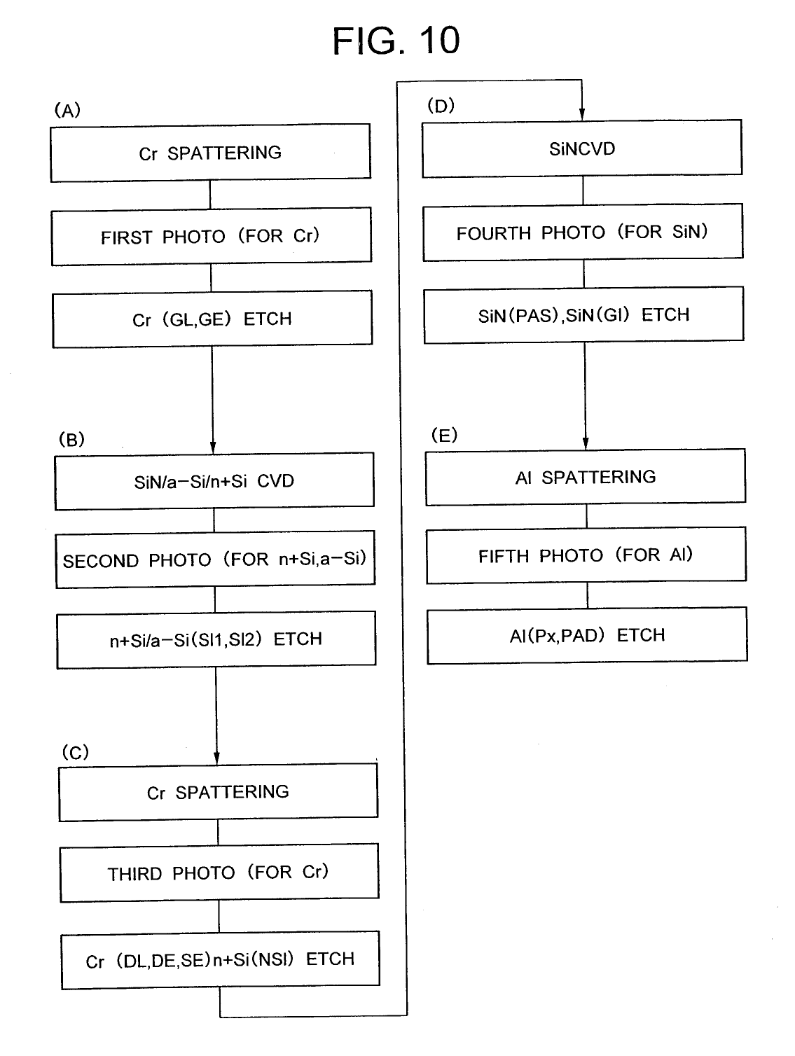

A flow of process for producing the reflection type liquid crystal display device according to the first embodiment of the present invention is shown in FIG. 10. For the reflection type liquid crystal display device the TFT substrate SUB1 is completed through five photolithography steps of (A) to (E), for example. The production process will be described below on a step-by-step basis. Reference will be made to FIGS. 6 to 8 as appropriate.

First, in the step (A), the transparent insulation substrate SUB1 is prepared, and a Cr coating is provided thereon in thickness of 100 to 300 nm, preferably 160 nm by, for example, sputtering process. Then, the photolithography technique is used to etch the Cr coating to form the scan signal line GL and the gate electrode GE. The extending portion of the scan signal line GL is formed on the area in which the terminal for the scan signal line GTM is formed.

Then, in the step (B), a silicon nitride coating is provided as the gate insulation film GI in thickness of about 200 to 700 nm, preferably 350 nm on the surface of the transparent insulation substrate SUB1 by, for example, plasma CVD process. In addition, an amorphous silicon coating is provided in thickness of 50 to 300 nm, preferably 200 nm on the entire surface of this gate insulation film GI by, for example, plasma CVD process, and then an amorphous silicon coating doped with phosphorous as an n type impurity is formed thereon in thickness of 10 to 100 nm, preferably 20 nm one after another.

Then, the photolithography technique is used to etch the amorphous silicon coating to form the island patterns S11 and S12 in the pixel area.

Then, in the step (C), the transparent insulation substrate SUB1 is prepared, and a Cr coating is provided thereon in thickness of 100 to 300 nm, preferably 160 nm by, for example, sputtering process. Then, the photolithography technique is used to etch the Cr coating to form the drain electrode DE and source electrode SE of the thin film transistor TFT, and the image signal line DL in the pixel area, and form the extending portion of the image signal line DL in the area in which the terminal for the image signal line DTM is formed. Thereafter, the amorphous silicon coating doped with phosphorous as an n type impurity is etched using as a mask a pattern with the Cr coating etched.

In the step (D), a silicon nitride coating as the surface protection film PAS for the thin film transistor TFT is provided in thickness of 200 to 900 nm, preferably 350 nm on the entire surface of the transparent insulation substrate SUB1 by, for example, plasma CVD process. Then, the photolithography technique is used to etch the surface protection film PAS to provide in the pixel area the through-hole TH for exposing a part of the upper surface of the source electrode SE of the thin film transistor TFT. In addition, in the area in which the scan signal line GTM is formed, the through-hole TH for exposing the upper surface of the gate insulation film GI located in the lower layer of the surface protection film PAS is provided to expose a part of the scan signal line GL. The through hole TH for exposing the extending portion of the image signal line DL is provided in the area in which the terminal for the image signal line DTM is formed.

Then, in the step (E), an alloy coating constituting reflection type pixel electrodes, having Al as a main component and including Nd (hereinafter referred to as “Al—Nd coating”) is provided in thickness of 50 to 300 nm, preferably 200 nm on the entire surface of the transparent insulation substrate SUB1 by, for example, sputtering process. Then, the photolithography technique is used to etch the Al—Nd coating. The pixel electrode PX connected to the source electrode SE through the through-hole TH and the terminal for the scan signal line GTM are formed in the pixel area, and the pad electrode PAD for connection is formed in the area in which the terminal for the image signal line DTM is formed. Through the steps described above, the structure on the TFT substrate side is completed.

On the other hand, the color filter CF produced by pigment dispersion process or the like, and the baffle pattern BM composed of Cr based metal layers or organic materials are formed in the CF substrate. Thereafter, an overcoat film as a planarized layer is formed, and the TFT substrate is bonded to the CF substrate using a sealing material or the like, with the liquid crystal layer LC placed therebetween. Then, the polarizing plate POL is placed outside the CF substrate, whereby the reflection type liquid crystal display device can be formed.

In accordance with the reflection type liquid crystal display device according to the first embodiment of the present invention, when the reflection type liquid crystal display device is produced with the first and second specifications, the island patterns SI1 and SI2 are formed at intervals corresponding to pixel pitches of the respective specifications in the step of forming the semiconductor layer constituting the active area of TFT. If the island pattern formed at a pitch identical to the pixel pitch is used as the semiconductor layer of the thin film transistor when reflection type liquid crystal display devices of respective specifications are produced, commonality of masks can be provided for those that are uses in formation of the semiconductor layer at the time when the reflection type liquid crystal display device with two specifications having different pixel pitches is produced.

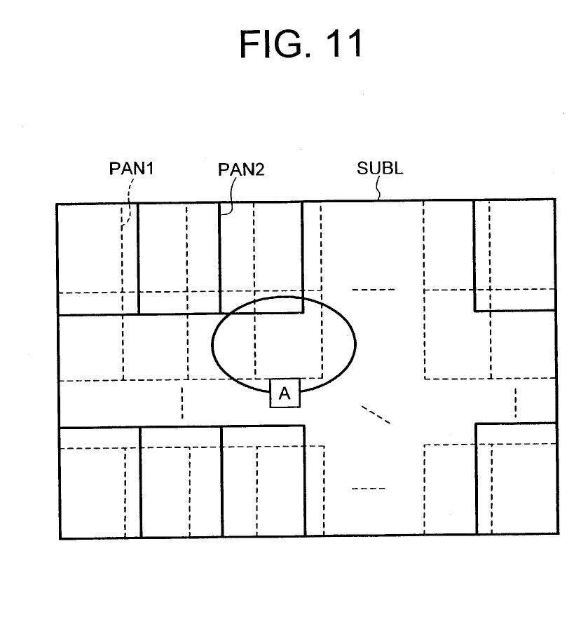

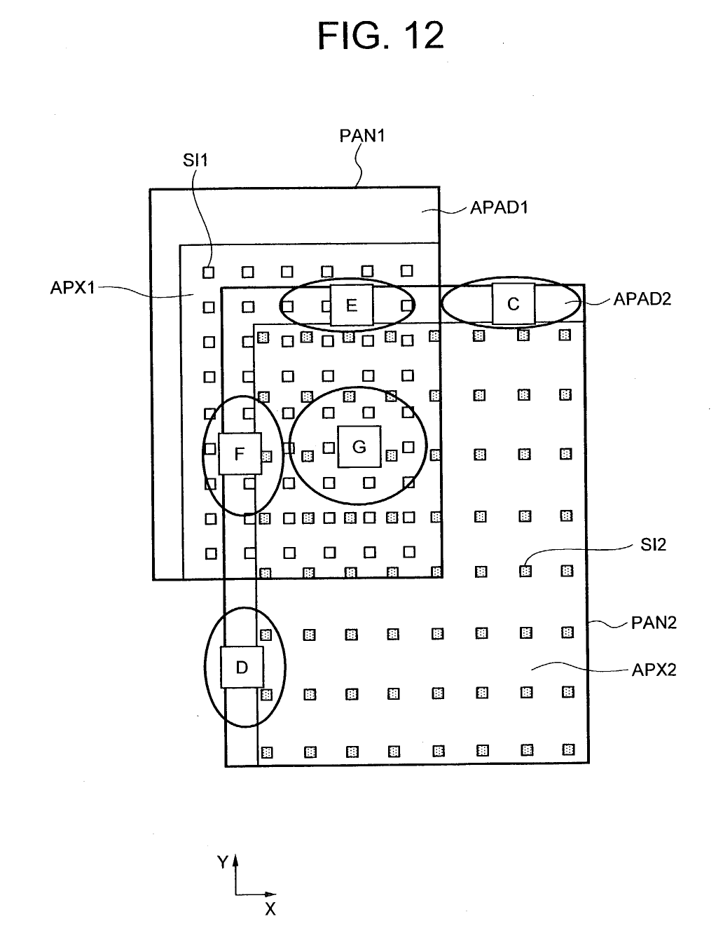

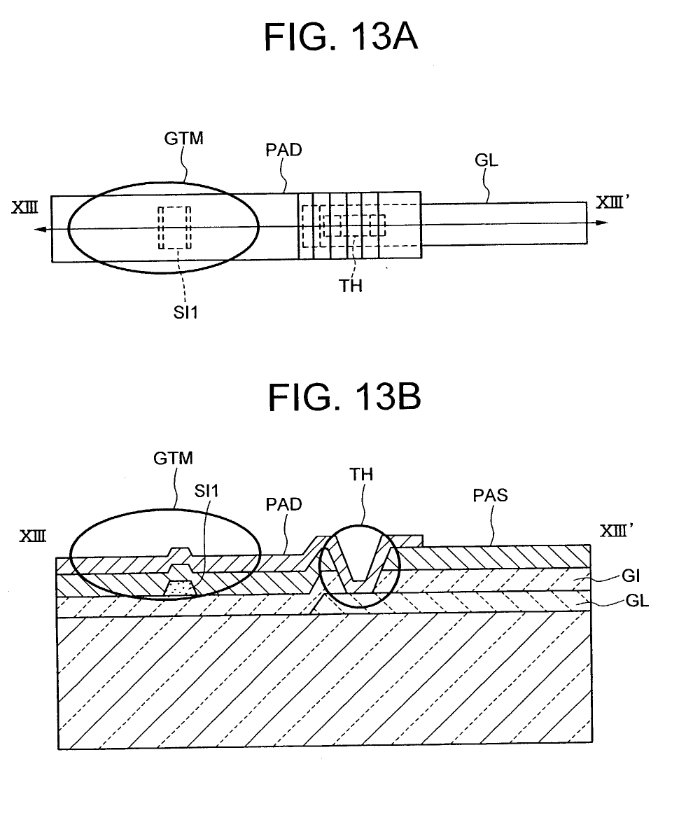

The reflection type liquid crystal display device according to the second embodiment of the present invention will now be described referring FIGS. 11 to 14. FIG. 11 shows the substrate outer shape of the reflection type liquid crystal display device formed on a large glass substrate as a starting substrate with the first and second specifications. FIG. 12 shows the placement of each substrate outer shape, and FIG. 13 shows connections between each of the scan signal line and image signal line and the external circuit.

For the reflection type liquid crystal display device according to the second embodiment of the present invention, commonality of photo masks is provided for those that are used in the step of producing the semiconductor layer when the reflection type liquid crystal display device is produced with first and second specifications different in pitch of pixel electrodes, substrate outer shape and size of the display screen. Furthermore, elements same as those of the first embodiment are given same symbols, and explanation of those elements is not presented.

In FIGS. 11 and 12, the area PAN1 surrounded by a dotted line shows the substrate outer shape of the reflection type liquid crystal display device produced with the first specification, and the area PAN 2 shows the substrate outer shape of the reflection type liquid crystal display device produced with the second specification. For clarification of the areas, the area PAN1 is shown by left-down slanting lines, and the area PAN2 is shown by right-down scanting lines.

Reference symbol SUBL denotes a large transparent insulation substrate for use in production process and capable of forming a plurality of reflection type liquid crystal display devices. Reference symbol APAD1 denotes a terminal formation area of the reflection type liquid crystal display device produced with the first specification, and reference symbol APAD2 denotes a terminal formation area of the reflection type liquid crystal display device produced with the second specification. Reference symbol APX1 denotes a display area of the reflection type liquid crystal display device produced with the first specification, and reference symbol APX2 denotes a display area of the reflection type liquid crystal display device produced with the second specification.

In the reflection type liquid crystal display device according to the second embodiment of the present invention, the plan view of the transparent insulation substrate SUB1 with the thin film transistor placed nearby in the reflection type liquid crystal display device is same as that of the reflection type liquid crystal display device according to the first embodiment, and therefore the description thereof is not presented.

FIG. 11 is a schematic diagram showing the TFT substrate being produced from the large transparent insulation substrate SUBL for use in the production process. Normally, in the step of producing a relatively small display device like a reflection type liquid crystal display device, a large transparent insulation substrate is used to produce lines for signals, thin film transistors or the like, followed by splitting (cutting) the substrate into pieces of desired sizes to provide a plurality of TFT substrates.

In this embodiment, the substrate outer shape PAN1 in the first specification is different from the substrate outer shape PAN2 in the second specification. The positions of the substrate outer shapes PAN1 and PAN2 relative to the large insulation substrate SUBL in the first and second specifications are also different. FIG. 12 is a schematic diagram of the area A (surrounded by ellipse) shown in FIG. 11. As described previously, the positions of the substrate outer shapes to the large insulation substrate SUBL in the first and second specifications are different, and therefore the display areas APX1 and APX2 shown in FIG. 12 are different in reference position unlike the reflection type liquid crystal display device of the first embodiment. In the reflection type liquid crystal display device according to the second embodiment of the present invention, the island pattern SI1 is formed in the display area APX1, and the island pattern SI2 is formed in the display area APX2.

In the reflection type liquid crystal display device according to the second embodiment of the present invention, the pitch of the island pattern SI1 aligned in the extending direction of the scan signal line (X direction) is made to be almost identical to the pitch of the pixel electrode neighboring in the extending direction of the scan signal line (X direction) in the first specification. The pitch of the island pattern SI1 aligned in the extending direction of the image signal line (Y direction) is almost identical to the pitch of the pixel electrode neighboring in the extending direction of the image signal line (Y direction) in the first specification.

The pitch of the island pattern SI2 aligned in the extending direction of the scan signal line (X direction) is made to be almost identical to the pitch of the pixel electrode neighboring in the extending direction of the scan signal line (X direction) in the second specification. The pitch of the island pattern SI2 provided in the extending direction of the image signal line (Y direction) is almost identical to the pitch of the pixel electrode neighboring in the extending direction of the image signal line (Y direction) in the second specification.

The sectional view of the reflection type liquid crystal display device according to the second embodiment of the present invention is not described here because it is similar to that of the reflection type liquid crystal display device according to the first embodiment of the present invention.

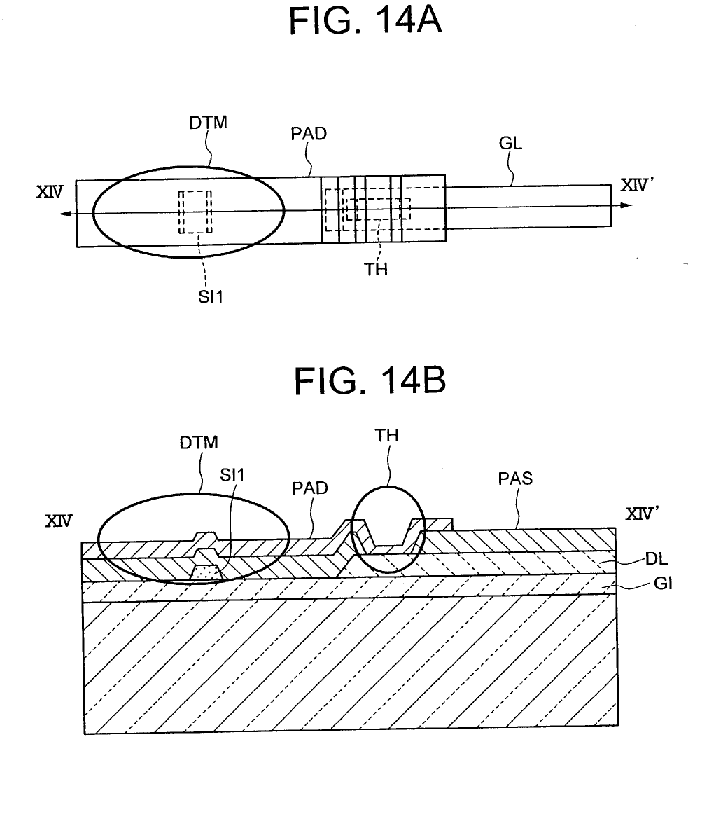

FIG. 13A is a plan view of the portion of the terminal for the scan signal line GTM placed in the area F of FIG. 12 when the reflection type liquid crystal display device according to the second embodiment of the present invention is produced with the second specification, and FIG. 13B is a sectional view taken along the XIII-XIII′ of FIG. 13A. FIG. 14A is a plan view of the portion of the terminal for the image signal line DTM placed in the area E of FIG. 12 when the reflection type liquid crystal display device is produced with the second specification, and FIG. 14B is a cross sectional view taken along the XIV-XIV′ line of FIG. 14A.

In the second specification, the island pattern SI1 functioning as the semiconductor layer of the thin film transistor in the first specification is formed in the area in which the terminal for the scan signal line GTM is formed. The pad electrode PAD is formed in such a manner as to ride over the island pattern SI1. By processing the island pattern into a sequential taper shape, possibilities of breaking of line being caused when the pad electrode PAD rides over the island pattern SI1 can be reduced.

As shown in FIG. 14, the island pattern that is used as the semiconductor layer of the thin film transistor in the first specification exists in the portion of the terminal for the image signal line DTM as in the case of the terminal for the scan signal line GTM, and by processing the island pattern into a sequential taper shape as in the case of the island pattern formed in the portion of the terminal for the scan signal line, possibilities of breaking of line being caused by ride-over can be reduced.

For the plan view of the portion of the terminal for the scan signal line GTM placed in the area D of FIG. 12, and the plan view of the portion of the terminal for the image signal line DTM placed in the area C of FIG. 12 in the reflection type liquid crystal display device produced with the second specification, descriptions are not presented here because they are similar to those of the reflection type liquid crystal display device according to the first embodiment of the present invention. For the schematic diagram of electric circuits of the reflection type liquid crystal display device according to the second embodiment of the present invention, a description is not provided here because it is similar to that of the first embodiment.

For the process flow for producing the reflection type liquid crystal display device of this embodiment, a description is not presented here because it is similar to that of the first embodiment.

According to the reflection type liquid crystal display device of this embodiment, the islands pattern SI1 and SI2 are formed with each pattern corresponding to the pixel pitch in each specification in the step of forming semiconductor layers, and each of the island patterns is used as the semiconductor layer of the thin film transistor when the reflection type liquid crystal display device of each specification is produced, thereby making it possible to provide commonality of masks for those that are used in formation of semiconductor layers when reflection type liquid crystal display devices of different specifications are produced.

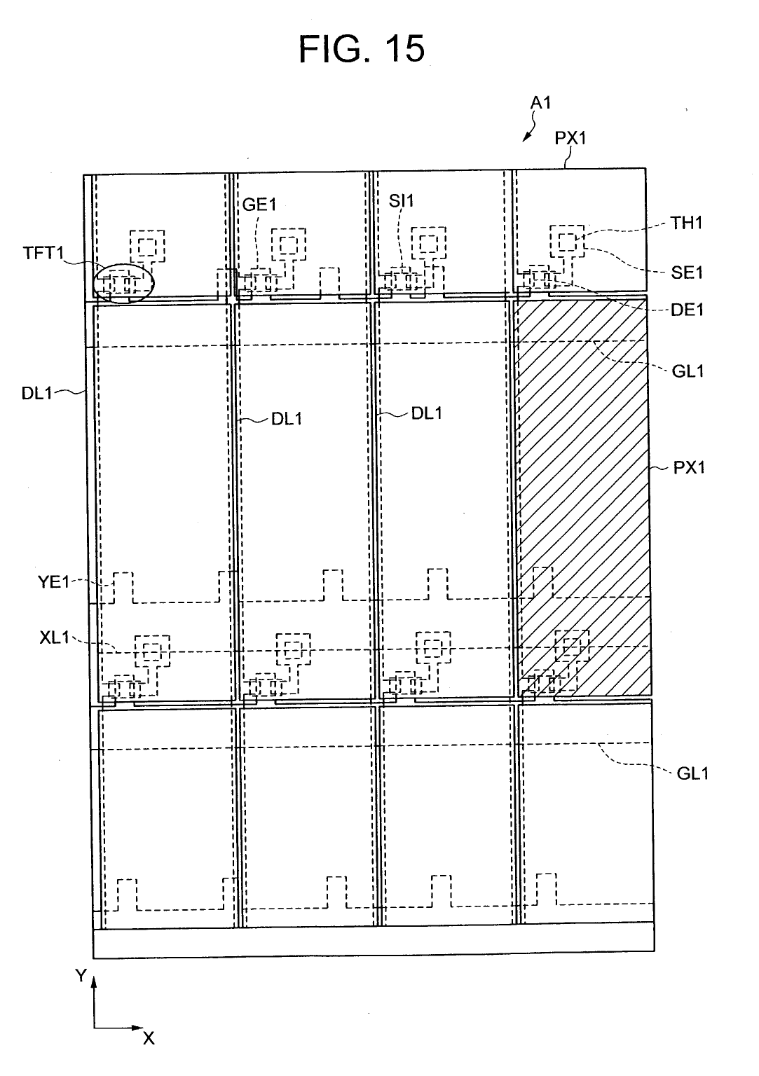

The reflection type liquid crystal display device according to the third embodiment of the present invention will now be described referring to FIGS. 15 to 18.

The reflection type liquid crystal display device according to third embodiment of the present invention represents an example in which commonality of photo masks is provided for those that are used in the step of forming scan signal lines and gate electrodes when reflection type liquid crystal display devices of two specifications different in pitch of pixel electrodes and identical in substrate outer shape and size of the display screen are produced.

In FIGS. 15 to 18, elements same as those of the reflection type liquid crystal display device of the first or second embodiment are given same symbols, and descriptions of those elements are not presented.

In these drawings, reference symbol XL denotes a longitudinal line pattern, reference symbol YE denotes a transverse electrode pattern, and reference symbol SI denotes a semiconductor layer of a thin film transistor.

FIG. 15 is a plan view of the transparent insulation substrate on which the thin film transistor is placed in the reflection type liquid crystal display device according to the third embodiment of the present invention, which is produced with the first embodiment.

The reflection type liquid crystal display device A1 produced with the first specification has a longitudinal line pattern XL1 (extending in the X direction) formed in the step of forming the scan signal line GL1 in such a manner that the pattern is provided almost in parallel with the scan signal line GL1. In addition, a transverse electrode pattern YE extending in the Y direction from the longitudinal line pattern XL1 is formed. Here, the pitch of the longitudinal line pattern XL is almost identical to the pitch of pixel electrodes PX2 neighboring in the extending direction of the image signal line DL in the second specification (Y direction).

In addition, the pitch of the transverse electrode pattern YE1 extending from the scan signal line XL1 is almost identical to the pitch of pixel electrodes PX2 neighboring in the extending direction of the scan signal line XL2 in the second specification (X direction). In the case of the reflection type liquid crystal display device produced with the second specification as described later, the longitudinal line pattern XL1 and transverse electrode pattern YE1 function as the scan signal line GL2 and the gate electrode GE of the reflection type liquid crystal display device A2.

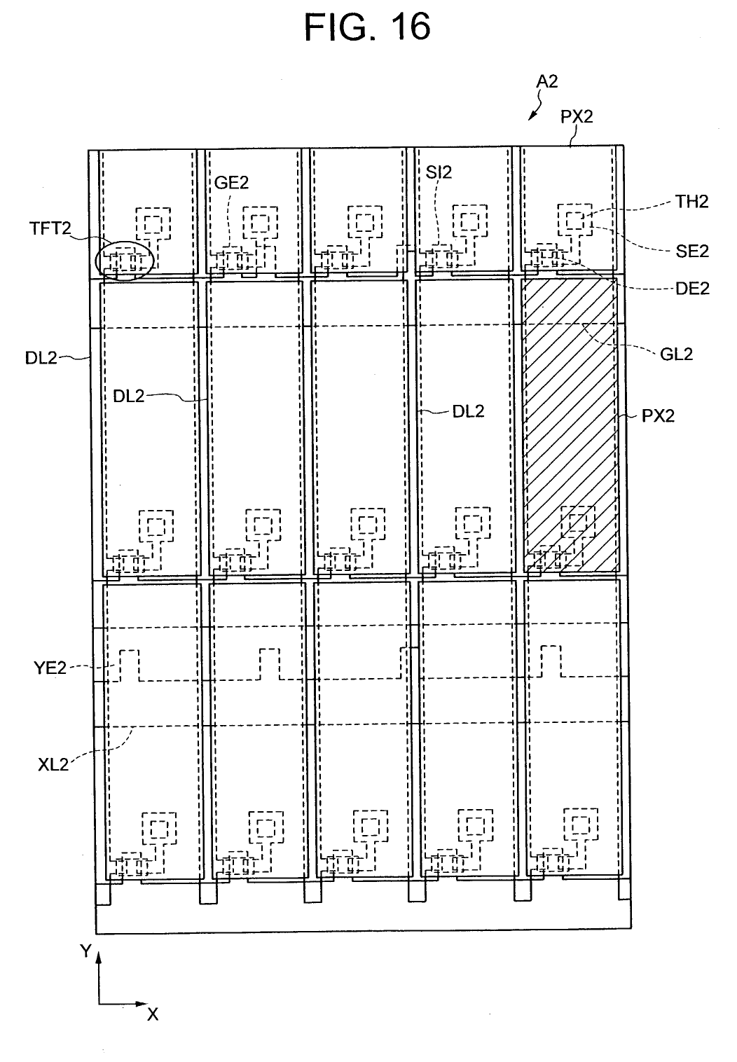

FIG. 16 is a plan view of the transparent insulation substrate on which the thin film transistor is placed in the reflection type liquid crystal display device according to the third embodiment of the present invention, which is produced with the second specification.

As shown in FIG. 16, the reflection type liquid crystal display device produced with the second specification also has a longitudinal line pattern XL2 formed in the step of forming the scan signal line GL2 in such a manner that the pattern is provided almost in parallel with the scan signal line GL2 similarly to the above described FIG. 15. In addition, a transverse electrode pattern YE2 extends from the longitudinal line pattern XL2. Here, the pitch of the longitudinal line pattern XL2 is almost identical to the pitch of pixel electrodes PX1 neighboring in the extending direction of the image signal line DL1 of the reflection type liquid crystal display device A1 in the first specification.

In addition, the pitch of the transverse electrode line pattern YE2 formed in such a manner as to align in the extending direction of the scan signal line XL2 (X direction) is almost identical to the pitch of pixel electrodes PX1 neighboring in the extending direction of the scan signal line GL1 (X direction) of the reflection type liquid crystal display device A1 produced with the first specification. The longitudinal line pattern XL2 and transverse electrode pattern YE2 correspond to the patterns that are used as the scan signal line GL1 and the gate electrode GE1 in the reflection type liquid crystal display device A1 produced with the first specification described above.

In addition, irrespective of whether the reflection type liquid crystal display device is produced with the first specification or the second specification, the gate electrode GE and transverse electrode pattern YE are usually connected to the pattern functioning as the scan signal line GL at a time.

In the reflection type liquid crystal display device according to the third embodiment of the present invention, the longitudinal line pattern XL and the transverse electrode pattern YE are each unused patterns. Here, as shown in FIG. 15, the source electrode SE1 may be superimposed on the line pattern XL1. However, since electrical isolation is provided between the source electrode SE1 and the line pattern XL1 via the gate insulation film GI, there are no possibilities that troubles associated with shorts or the like arise. However, a stray capacitance occurs between the source electrode SE1 and the line pattern XL1, and therefore a capacitance not causing degradation of display quality or the like should be designed. Also, a stray capacitance occurs between the longitudinal line pattern and the pixel electrode, and therefore a capacitance not causing degradation of display quality or the like should be designed.

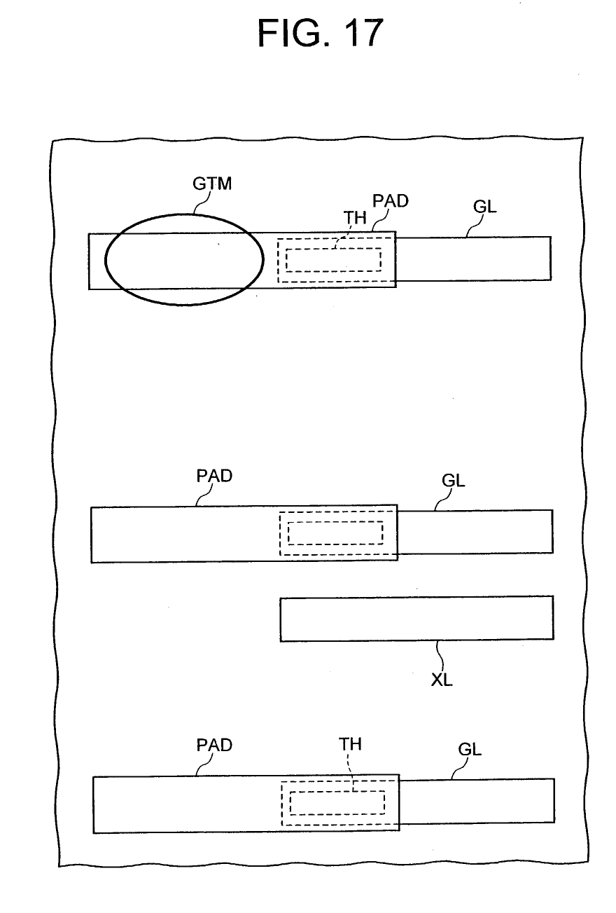

FIG. 17 shows a plan view of the area in which the terminal for the scan signal line GTM is formed, in the reflection type liquid crystal display device according to the third embodiment of the present invention. The extending portion of the longitudinal line pattern XL is formed in the area in which the terminal for the scan signal line GTM is formed, in addition to the extending portion of the scan signal line GL. It is only the scan signal line GL that requires input of signals from the outside. In the reflection type liquid crystal display device according to the third embodiment of the present invention, external signals are inputted only to the scan signal line GL, and therefore the through-hole TH and the pad electrode are formed only in the extending portion of the scan signal line GL while no through-hole TH and pad electrode PAD are formed in the extending portion of the line pattern. In this way, by selectively forming the pad electrode PAD, signals can be inputted exclusively to a line requiring the signals.

Furthermore, for the plan view of the portion of the terminal for the image signal line DTM of the reflection type liquid crystal display device according to the third embodiment of the present invention, a description is not presented here because it is similar to that of the reflection type liquid crystal display device of the first embodiment. Also, for the schematic diagram of electric circuits, a description is not presented here because it is similar to that of the reflection type liquid crystal display device of the first embodiment.

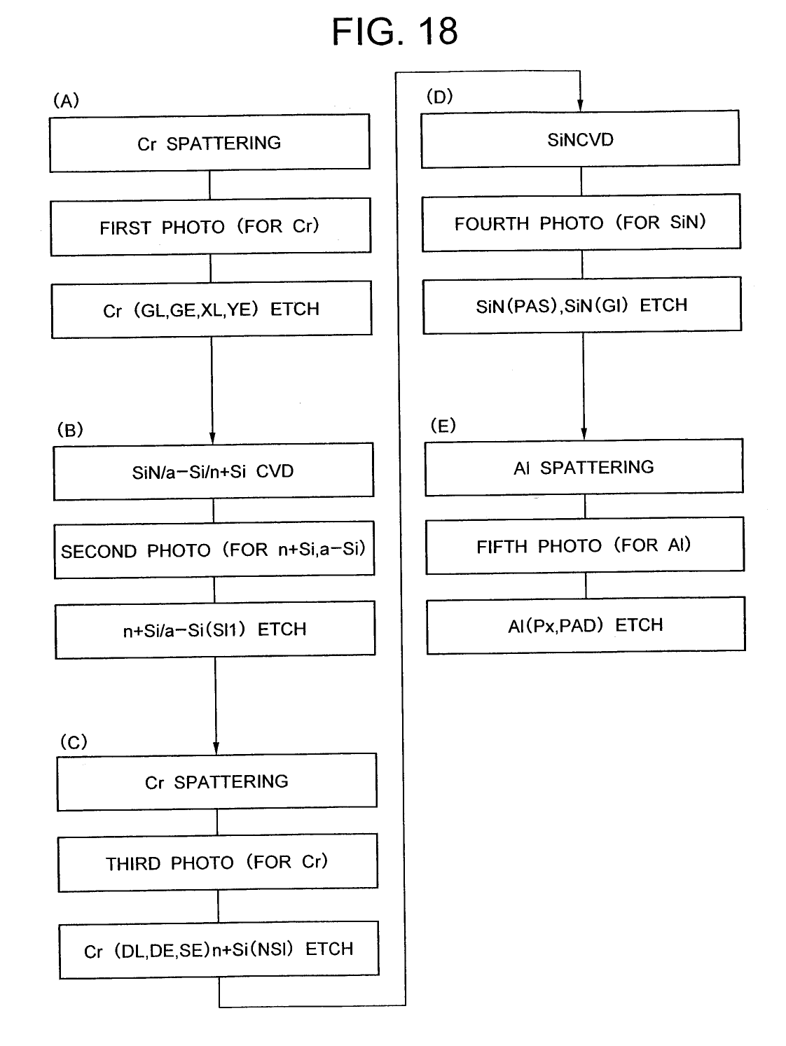

FIG. 18 shows a process flow for producing the reflection type liquid crystal display device according to the third embodiment of the present invention. Furthermore, for the production process of this embodiment, steps (C) to (E) will not be described because they are identical to their counterparts of the production process of the first embodiment.

First, in the step (A), the transparent insulation substrate SUB1 is prepared, and a Cr coating is provided thereon in thickness of 100 to 300 nm, preferably 160 nm by, for example, sputtering process. Then, the photolithography technique is used to etch the Cr coating to form the extending portions of the scan signal line GL and the longitudinal line pattern XL in the area in which the scan signal line GL, the longitudinal line pattern XE, the gate electrode GE, the transverse electrode pattern YE and the terminal for the scan signal line GTM.

Then, in the step (B), a silicon nitride coating functioning as the gate insulation film GI is provided in thickness of about 200 to 700 nm, preferably 350 nm on the surface of the transparent insulation substrate SUB1 by, for example, plasma CVD process. In addition, an amorphous silicon coating is provided in thickness of 50 to 300 nm, preferably 200 nm on the surface of this gate insulation film GI by, for example, plasma CVD process, and then an amorphous silicon coating doped with phosphorous as an n type impurity is formed thereon in thickness of 10 to 100 nm, preferably 20 nm one after another.

Then, the photolithography technique is used to etch the amorphous silicon coating to form the semiconductor layer SI of the thin film transistor TFT in the pixel area.

Through the above steps, the TFT substrate is completed.

According to the reflection type liquid crystal display device of the third embodiment of the present invention, in the step of forming the scan signal line GL1 in the process for producing the reflection type liquid crystal display device A1 of first specification, the longitudinal line pattern XL1 is formed at an interval almost identical to the pitch of pixel electrodes PX2 neighboring in the extending direction of the image signal line DL2 (Y direction) of the reflection type liquid crystal display device of the second specification, and the transverse electrode pattern YE1 in the first specification is formed at a pitch identical to the pitch of pixel electrodes PX2 neighboring in the extending direction of the scan signal line GL1 (X direction) in the second specification, whereby commonality of photo masks can be provided for those that are used in formation of the scan signal line GL and the gate electrode GE when reflection type liquid crystal display devices having two different pitches are produced.

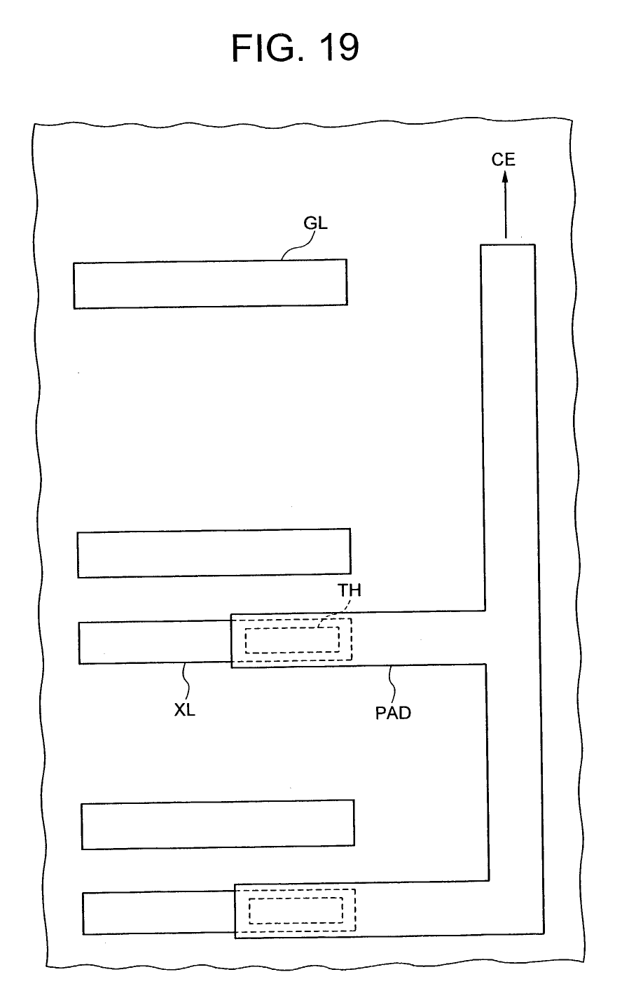

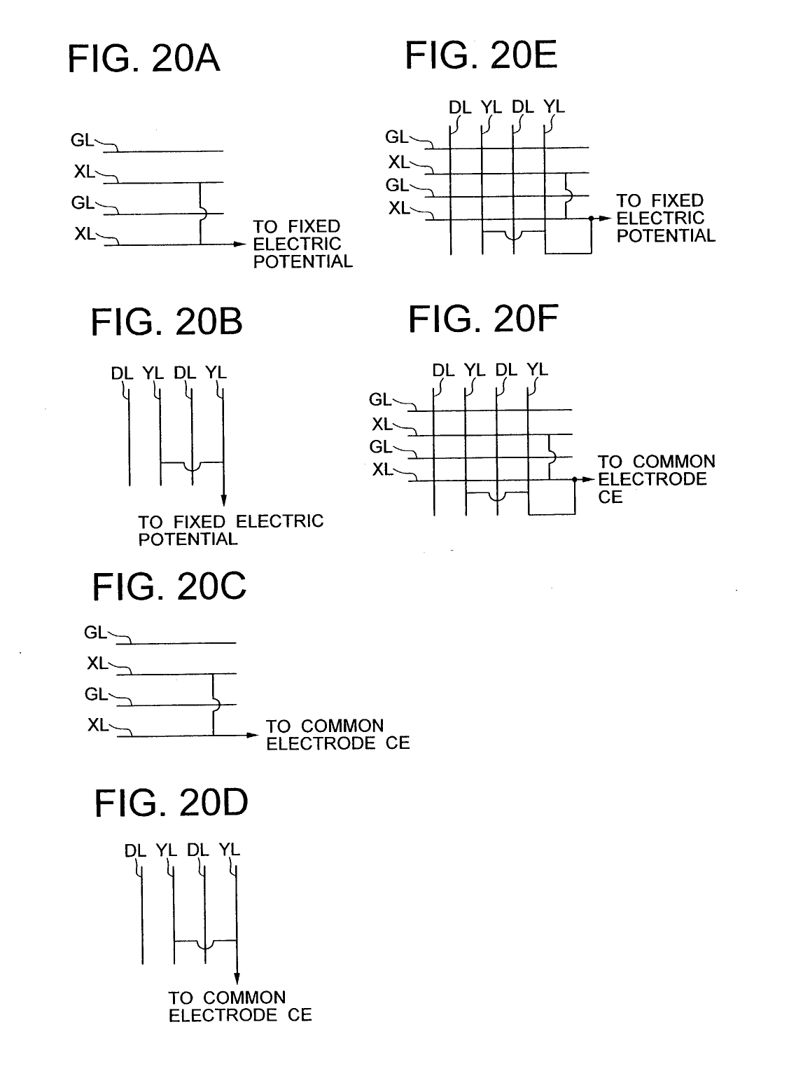

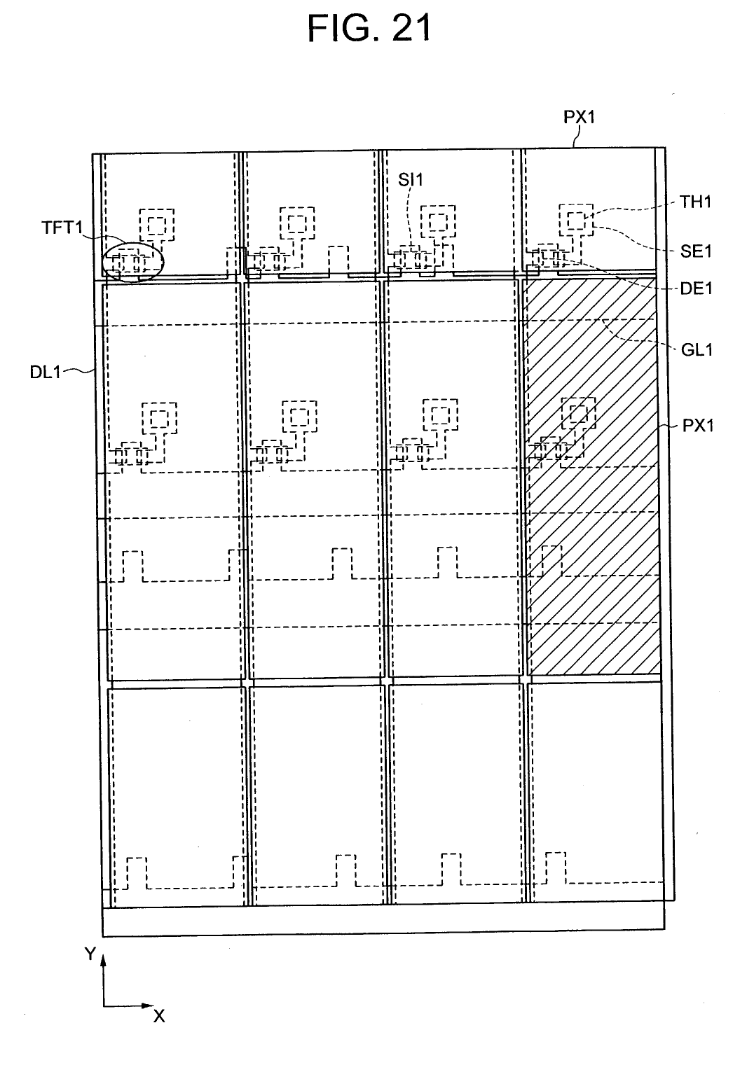

The reflection type liquid crystal display device according to the fourth embodiment of the present invention will now be described referring to FIGS. 19 and 20.

In the reflection type liquid crystal display device of the fourth embodiment of the present invention, commonality of photo masks is provided for those that are used in the step of forming the scan signal line and the gate electrode when reflection type liquid crystal display devices of first and second specifications different in pitch of pixel electrodes and identical in substrate outer shape and size of the display screen are produced.

In FIGS. 19 and 20, elements identical to those of the aforesaid embodiments are given identical symbols to avoid duplication of description.

For the plan view of the transparent insulation substrate on which the thin film transistor is placed in the case where the reflection type liquid crystal display device according to the fourth embodiment of the present invention is produced with the first specification, and the equivalent plan view in the case where the reflection type liquid crystal display device is produced with the second specification, descriptions are not presented here because they are same as those of the reflection type liquid crystal display device of the third embodiment of the present invention. Also, for the plan view of the area in which the terminal for the scan signal line GTM is formed, a description is not presented here because it is same as the equivalent plan view of the third embodiment. For the plan view of the area in which the terminal for the image signal line DTM is formed, a description is not presented here because it is same as the equivalent plan view of the first embodiment. For the electric circuit diagram, a description is not presented because it is same as that of the first embodiment. For the process flow, a description is not presented because it is same as that of the third embodiment.

FIG. 19 shows a structure on the side opposite to the portion of the terminal for the scan signal line. As shown in FIG. 19, the extending portion of the longitudinal line pattern XL and the extending portion of the scan signal line GL are formed on the side opposite to the terminal for the scan signal line. The through-hole TH is selectively provided on the longitudinal line pattern XL to expose a part of the extending portion of the longitudinal line pattern XL. In addition, all the longitudinal line pattern XL on which the pad electrode PAD is formed is connected. Here, voltage equal to that for the common signal electrode is applied to the pad electrode PAD connected to the longitudinal line pattern XL.

FIGS. 20A to 20F are circuit diagrams of alternative including FIG. 19. FIG. 20F shows a structure same as FIG. 19 using a circuit diagram. FIG. 20A shows an example in which the extending portions of a plurality of longitudinal lines XL as non-selective patterns are connected to one another to keep them at a fixed electric potential. FIG. 20B shows an example in which the extending portions of a plurality of transverse lines YL as non-selective patterns are connected to one another to keep them at a fixed electric potential. FIG. 20C shows an example in which the extending portions of a plurality of longitudinal lines XL as non-selective patterns are connected to one another to connect them to the common electrode CE. FIG. 20D shows an example in which the extending portions of a plurality of transverse lines YL as non-selective patterns are connected to one another to connect them to the common electrode CE. FIG. 20E shows an example in which the extending portions of a plurality of transverse lines YL and a plurality of longitudinal lines XL as non selective patterns are connected to one another to keep them at a fixed electric potential. FIG. 20F shows an example in which the extending portions of a plurality of transverse lines YL and a plurality of longitudinal lines XL as non selective patterns are connected to one another to connect them to the common electrode CE, which represents a same example as FIG. 19.

By keeping the extending portion of the nonselective line pattern at a fixed electric potential, or connecting the same to the common electrode, a capacitance between the line pattern and the pixel electrode that may cause degradation of display quality can be used as a retention capacitance of liquid crystal, thus making it possible to improve display quality of the display unit.

The reflection type liquid crystal display device of the fifth embodiment of the present invention will now be described referring to FIG. 21. The reflection type liquid crystal display device of the fifth embodiment of the present invention represents an example in which commonality of photo masks is provided for those that are used in the step of forming the scan signal line and the gate electrode when reflection type liquid crystal display devices of first and second specifications different in pitch of pixel electrodes and identical in substrate outer shape and size of the display screen are produced.

In FIG. 21, elements identical to those of the reflection type liquid crystal display devices of the aforesaid embodiments are given identical symbols to avoid duplication of description.

FIG. 21 is a plan view of the transparent insulation substrate on which the thin film transistor is placed in the reflection type liquid crystal display device of the fifth embodiment of the present invention, which is produced with the first specification. The reflection type liquid crystal display device of the fifth embodiment of the present invention has a structure in which the positions of the scan signal line GL1 and the thin film transistor TFT1 relative to the pixel electrode PX1 (area given slanting lines) vary for each pixel electrode neighboring in the extending direction of the image signal line (Y direction). Such a structure makes it possible to avoid superimposition of the source electrode SE on the pixel electrode PX in the reflection type liquid crystal display device of the third embodiment of the present invention. That is, the reflection type liquid crystal display device having such a structure as shown in FIG. 20 has an advantage that a capacitance occurring between the source electrode SE1 and the longitudinal line pattern XL1 can be reduced, and thus design of the capacitance is facilitated.

The reflection type liquid crystal display device of the fifth embodiment of the present invention represents one example of reducing a capacitance. In addition, it is also possible to make an optimum design of capacitance by modifying layouts of the scan signal line GL1 and the thin film transistor TFT1.

For the plan view of the area in which the terminal for the scan signal line GTM is formed in the reflection type liquid display device of the fifth embodiment of the present invention, a description is not presented here because it is same as that of the reflection type liquid crystal display device of the third embodiment. For the plan view of the portion of the terminal for the image signal line DTM, a description is not presented here because it is same as that of the reflection type liquid crystal display device of the first embodiment. For the schematic diagram of electric circuits, a description is not presented here because it is same as that of the first embodiment. For the process flow, a description is not presented here because it is same as that of the third embodiment.

According to the reflection type liquid crystal display device of the fifth embodiment of the present invention, in the step of forming the scan signal line GL1 when the reflection type liquid crystal display device is produced with the first specification, the longitudinal line pattern XL1 is formed at an interval almost identical to the pitch of pixel electrodes neighboring in the extending direction of the image signal line DL2 (Y direction) of the second specification, and the transverse electrode pattern YE1 is formed at an interval identical to the pitch of pixel electrodes neighboring in the extending direction of the scan signal line GL1 (X direction), whereby commonality of photo masks can be provided for those that are used in formation of the scan signal line GL1 and the gate electrode GE1 when reflection type liquid crystal display devices having two different pixel pitches are produced.

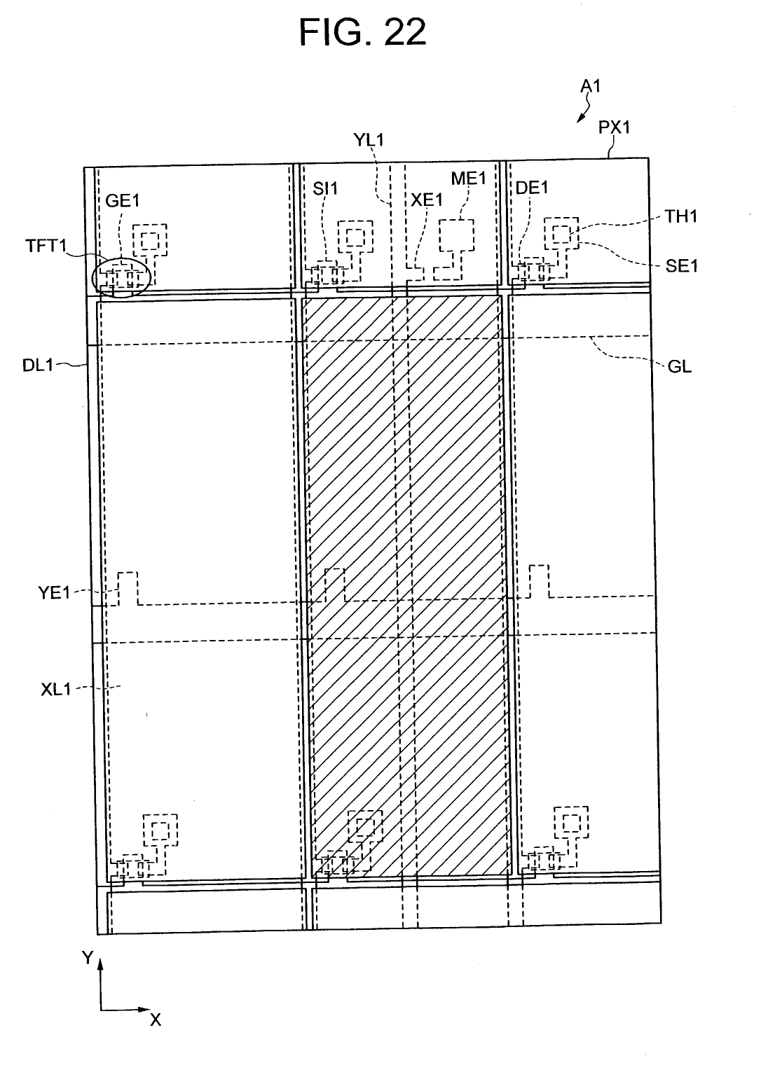

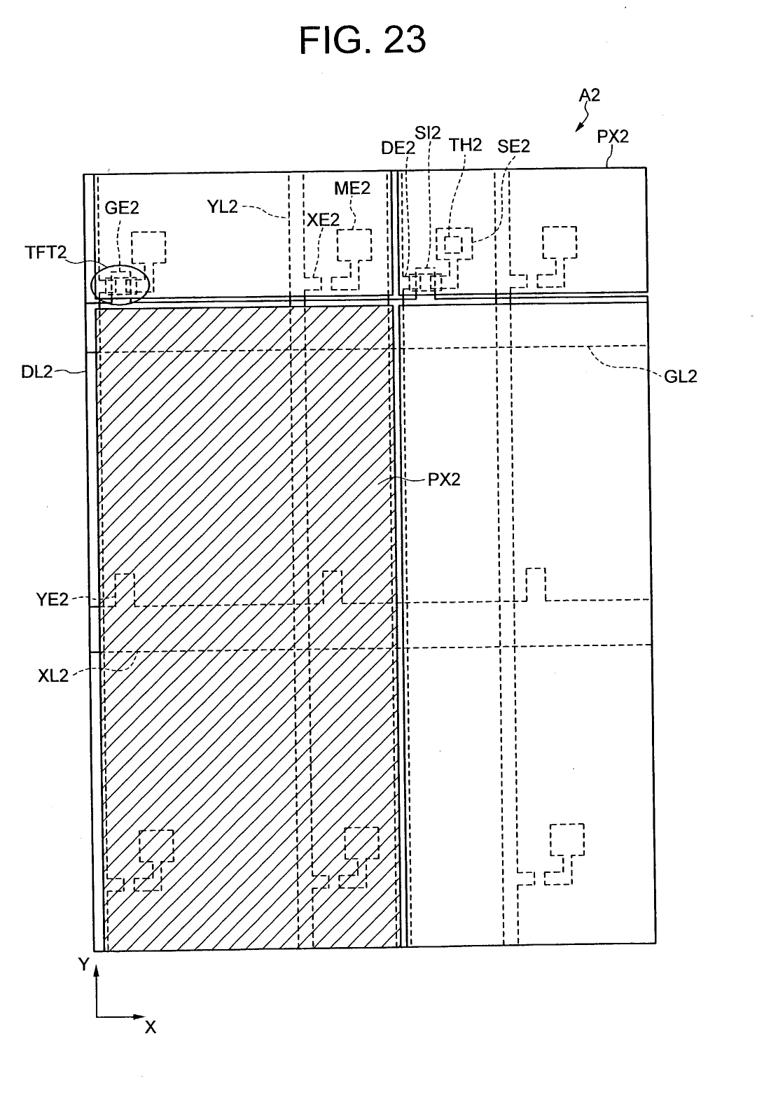

The reflection type liquid crystal display device of the sixth embodiment of the present invention will now be described referring to FIGS. 22 to 25. The reflection type liquid crystal display device of this embodiment represents an embodiment in which commonality of photo masks is provided for those that are used in the step of forming image signal lines, source electrode and drain electrodes when reflection type liquid crystal display devices of first and second specifications different in pitch of pixel electrodes and identical in substrate outer shape and size of the display screen are produced.

Elements identical to those of any of the aforesaid first to fifth embodiments are given identical symbols to avoid duplication of description. Reference symbol YE denotes a transverse line pattern, reference symbol XE denotes a longitudinal electrode pattern, and reference symbol ME denotes a cross electrode pattern.

FIG. 22 is a plan view showing the structure of the transparent insulation substrate on which the thin film transistor is placed in the reflection type liquid crystal display device produced with the first specification. The reflection type liquid crystal display device produced with the first specification has a transverse pattern YL1 formed in the step of forming the image signal line DL1 in such a manner the pattern is provided in almost parallel with the scan signal line DL1. In addition, a longitudinal electrode pattern XE1 is connected to the transverse line pattern YL1. In addition, a cross electrode pattern ME1 is formed in a position opposite to the longitudinal electrode pattern YE1. They are usually formed as patterns in the same layer.

The pitch of the transverse line pattern YL1 is almost identical to the pitch of pixel electrodes neighboring in the extending direction of the image signal line DL1 in the second specification. In addition, the pitches of the longitudinal electrode pattern XE1 and cross electrode pattern ME1 in the extending direction of the image signal line DL1 (Y direction) are almost identical to the pitch of the pixel electrode PX2 neighboring in the extending direction of the image signal line DL (Y direction). The transverse line pattern YL1, the longitudinal electrode pattern XE1 and the cross electrode pattern ME1 correspond to the image signal line DL2, the drain electrode DE2 and the source electrode SE2, respectively, of the reflection type liquid crystal display device produced with the second specification as described later.

FIG. 23 is a plan view showing the transparent insulation substrate on which the thin film transistor TFT2 is placed in the reflection type liquid crystal display device A2 produced with the second specification. The reflection type liquid crystal display device A2 produced with the second specification also has a transverse pattern formed in the step of forming the image signal line in such a manner the pattern is provided in almost parallel with the image signal line as in the case of FIG. 22 described above. In addition, a longitudinal electrode pattern XE2 is connected to the transverse line pattern YL2, and a cross electrode pattern ME2 is formed in a position opposite to the longitudinal electrode pattern XE2. The transverse line pattern YL2, longitudinal electrode pattern XE2 and cross electrode pattern ME2 are patterns that are used in the first specification as the image signal line DL1, the drain electrode DE1 and the source electrode SE1. Also, the drain electrode DE and the longitudinal electrode pattern XE may be connected to the image signal line DL at a time.

In the reflection type liquid crystal display device of this embodiment, the transverse line pattern YL and longitudinal electrode pattern XE are each unused patterns. A stray capacitance occurs between the transverse line pattern YL and the pixel electrode, and therefore a capacitance not causing degradation of display quality or the like should be designed.

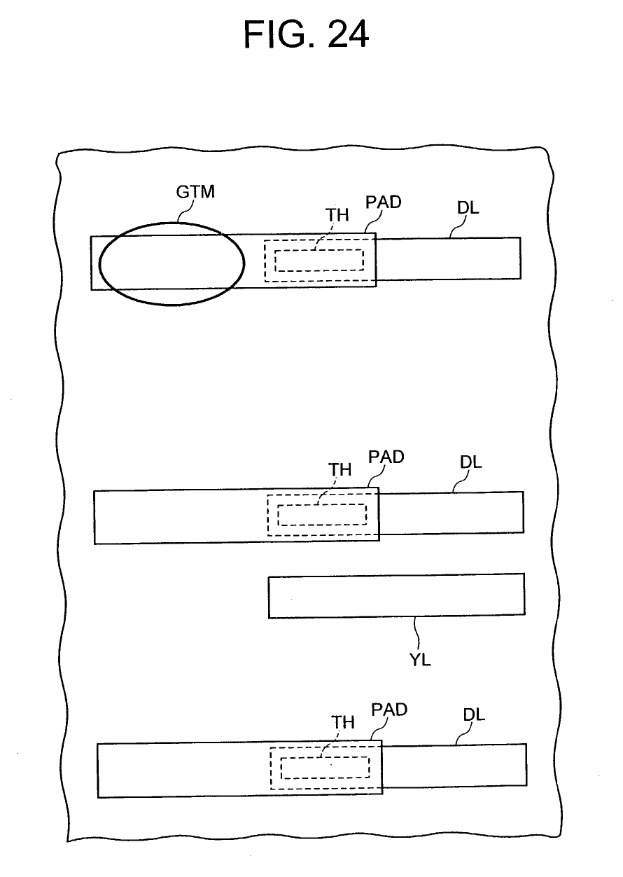

FIG. 24 shows a plan view of the area in which the terminal for the image signal line DTM is formed. The extending portion of the transverse line pattern YL is formed in the area in which the terminal for the image signal line DTM is formed, in addition to the extending portion of the image signal line DL. It is only the image signal line DL that requires input of signals from the outside. Then, in the reflection type liquid crystal display device of this embodiment, for inputting external signals only to the image signal line DL, the through-hole TH for connecting the pad electrode PAD to the extending portion of the pad electrode PAD and the image signal line DL is provided only in the extending portion of the image signal line DL. Neither the through-hole TH or the pad electrode PAD is provided in the extending portion of the transverse line pattern YL. In this way, by selectively forming the pad electrode PAD and through-hole TH, signals can be inputted exclusively to the image signal line DL.

Furthermore, for the plan view of the portion of the terminal for the scan signal line CTM, a description is not presented here because it is similar to that of the first embodiment. For the schematic diagram of electric circuits, a description is not presented here because it is similar to that of the first embodiment.

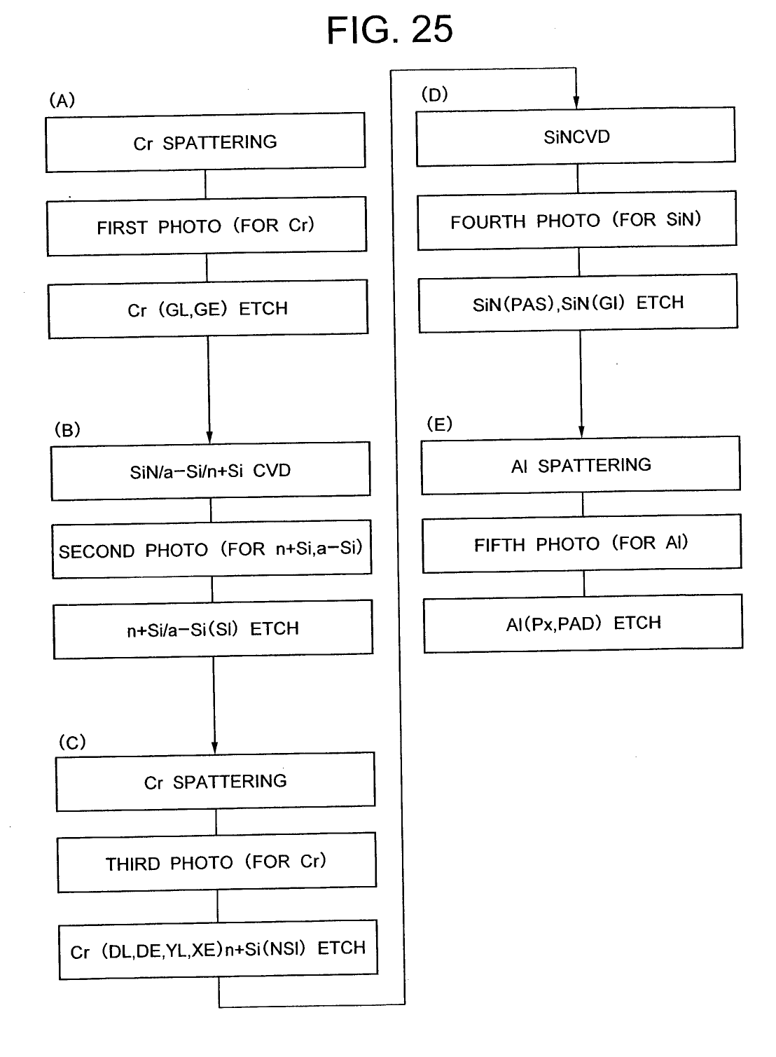

FIG. 25 shows a process flow for producing the reflection type liquid crystal display device according to this embodiment. In this embodiment, the step (A) is similar to its counterpart of the first embodiment, and the steps (B), (D) and (E) are similar to their counterparts of the third embodiment, and therefore these steps are not described here.

In the step (C), the transparent insulation substrate SUB1 is prepared, and a Cr coating is provided on the entire surface thereof in thickness of 100 to 300 nm, preferably 160 nm by, for example, sputtering process. Then, the photolithography technique is used to etch the Cr coating to form the drain electrode DE and source electrode SE of the thin film transistor TFT, the image signal line DL, the transverse line pattern YL and the longitudinal electrode pattern XE, and form the extending portion of the image signal line DL in the area in which the terminal for the image signal line DTM.

Thereafter, an amorphous silicon coating doped with phosphorous as a n-type impurity is etched using as a mask the pattern with the Cr coating etched. The TFT substrate is completed through the above steps.

According to this embodiment, in the step of forming the image signal line DL when the reflection type liquid crystal display device is produced with the first specification, the transverse line pattern YL is formed at an interval almost identical to the pitch of pixel electrodes neighboring in the extending direction of the image signal line in the second specification, the longitudinal electrode pattern XE is formed at an interval identical to the pitch of pixel electrodes neighboring in the extending direction of the scan signal line (X direction), and the cross electrode pattern ME is formed face to face with the longitudinal electrode pattern XE, whereby commonality of photo masks can be provided for those that are used in formation of image signal lines DL, drain electrodes DE and source electrodes SE when reflection type liquid crystal display devices are produced with two specifications different in pitch of pixel electrodes.

Cases where one layer is common between the first and second specifications have been described above. Now, processes in which commonality of layers is provided for two or more layers between the first and second specifications will be described.

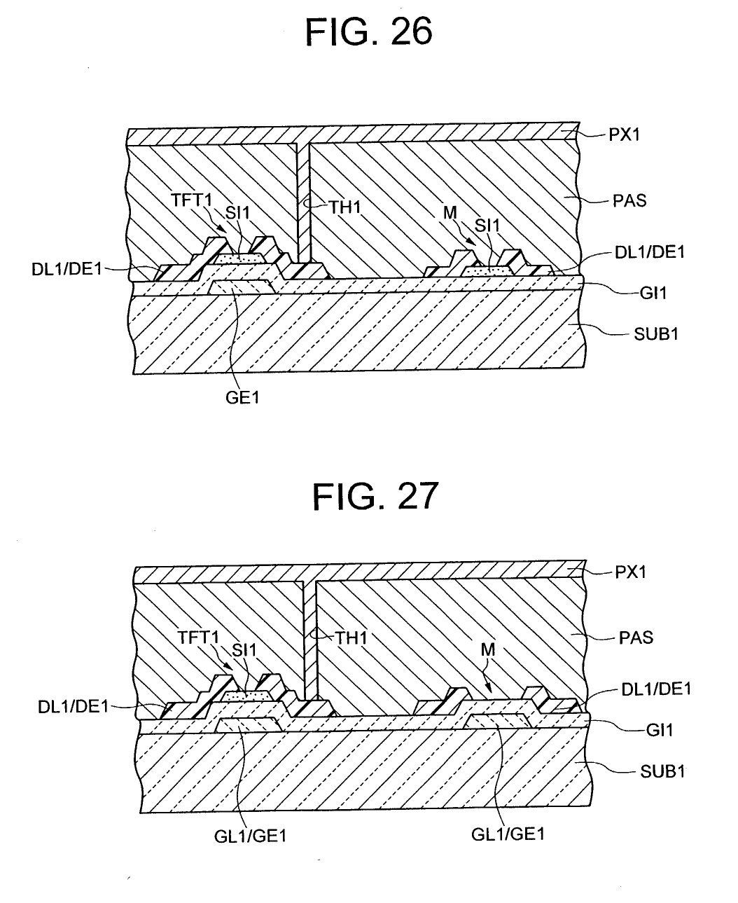

First, the seventh embodiment of the present invention in which commonality of layers is provided for two layers between the first and second specifications will be described referring to FIGS. 26 to 30.

FIG. 26 is a partial sectional view of the reflection type liquid crystal display device produced with the first specification when commonality of photo masks is provided for those for forming the semiconductor layer SI1 and the image signal line and concurrently drain electrode DL1/DE1 between the first and second specifications. The thin film transistor TFT1 and a separate pattern M are formed on the substrate SUB1. For the thin film transistor TFT1 and separate pattern, two layers, namely the semiconductor layer SI1 and the image signal line and concurrently drain electrode DL1/DE1 are formed in the same layer. The source electrode SE1 of the thin film transistor TFT1 is connected to the pixel electrode PX1 through the through-hole TH1. The separate pattern M has no through-hole TH provided therein, and thus is connected to no pixel electrode PX.

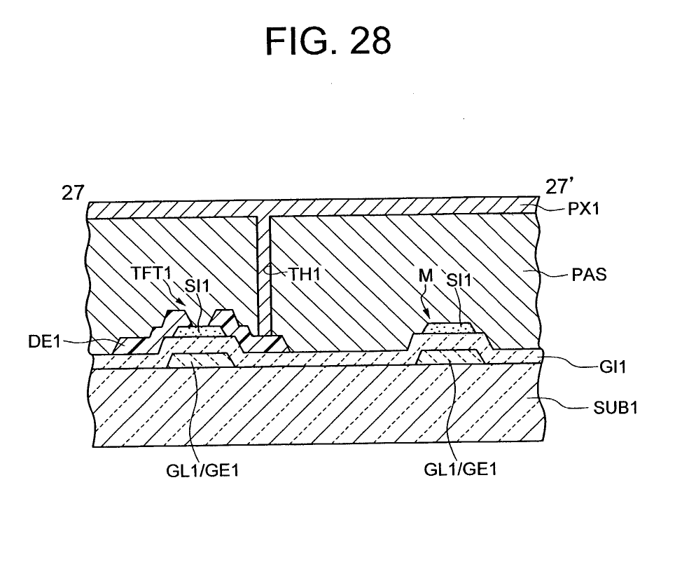

FIG. 27 is a partial sectional view of the reflection type liquid crystal display device produced with the first specification when commonality of photo masks is provided for those for forming the scan signal line and concurrently gate electrode GL1/GE1, and the image signal line and concurrently drain electrode DL1/DE1 between the first and second specifications. The thin film transistor TFT1 and a separate pattern M are formed on the substrate SUB1. For the thin film transistor TFT1 and separate pattern, two layers, namely the scan signal line and concurrently gate electrode GL1/GE1, and the image signal line and concurrently drain electrode DL1/DE1 are formed in the same layer. The source electrode SE1 of the thin film transistor TFT1 is connected to the pixel electrode PX1 through the through-hole TH1. The separate pattern M has no through-hole TH provided therein, and thus is connected to no pixel electrode PX.

FIG. 28 is a partial sectional view of the reflection type liquid crystal display device produced with the first specification when commonality of photo masks is provided for those for forming the scan signal line and concurrently gate electrode GL1/GE1, and the image signal line and concurrently drain electrode DL1/DE1 between the first and second specifications. The thin film transistor TFT1 and a separate pattern M are formed on the substrate SUB1. For the thin film transistor TFT1 and separate pattern, two layers, namely the scan signal line and concurrently gate electrode GL1/GE1, and the image signal line and concurrently drain electrode DL1/DE1 are formed in the same layer. The source electrode SE1 of the thin film transistor TFT1 is connected to the pixel electrode PX1 through the through-hole TH1. The separate pattern M has no through-hole TH provided therein, and thus is connected to no pixel electrode PX1.

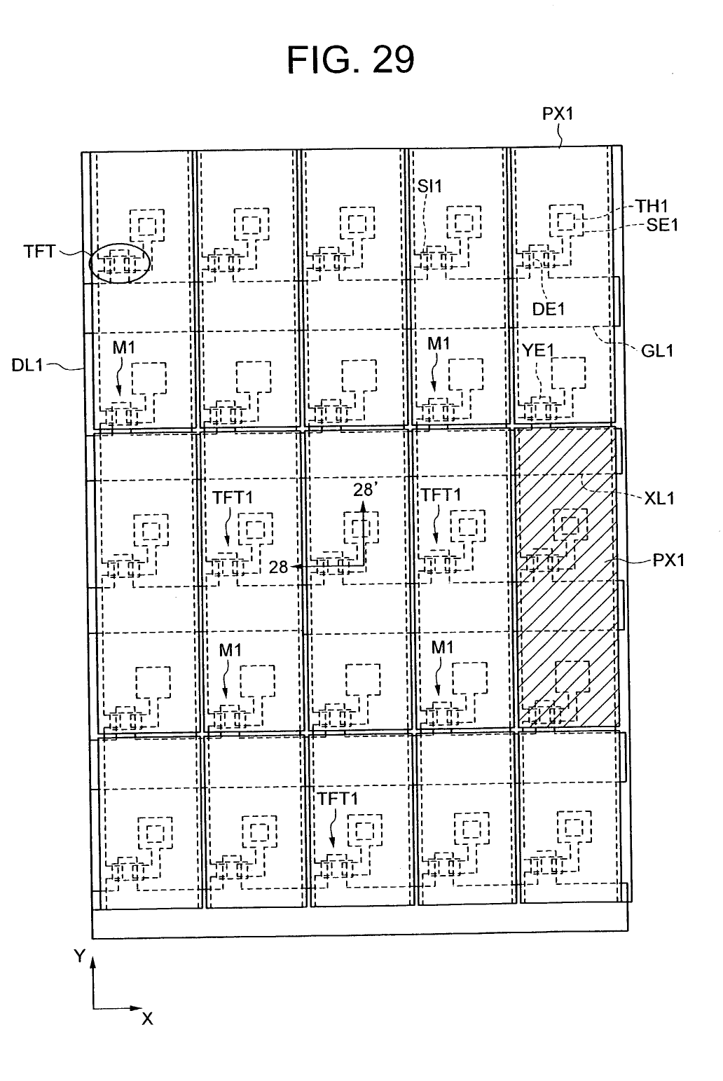

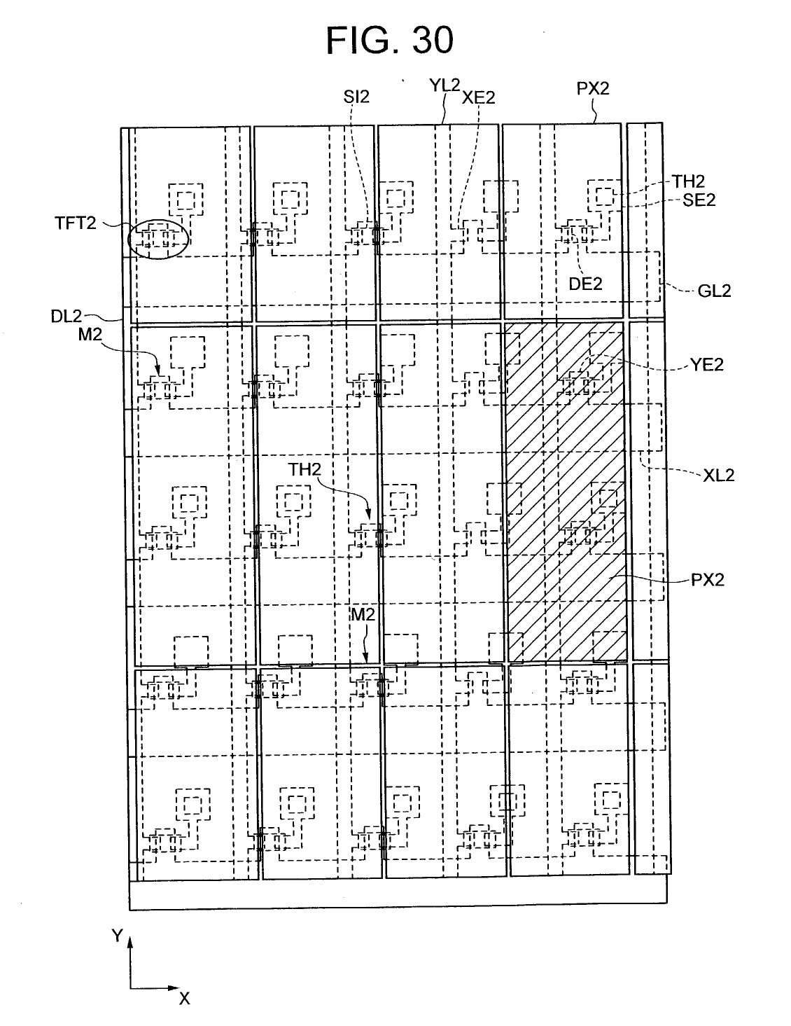

FIGS. 29 and 30 are plan views of two layers, namely the scan signal line GL1 and concurrently gate electrode GE, and the image signal line and concurrently drain electrode DL/DE being formed in the same layer as an example of commodity of two layers. FIG. 29 is a plan view in the case of the reflection type liquid crystal display device produced with the first specification, which corresponds to FIG. 27. Furthermore, FIG. 28 is a sectional view taken along the 28-28′ line of FIG. 29. FIG. 30 is a plan view in the case of the reflection type liquid crystal display device produced with the second specification.

As shown in FIG. 29, in the reflection type liquid crystal display device produced with the first specification are formed the thin film transistor TFT1 and separate pattern M1 for which two layers, namely the scan signal line and concurrently gate electrode GL1/GE1, and the image signal line and concurrently drain electrode DL1/DE1 are formed in the same layer.

The source electrode SE1 of the thin film transistor TFT1 is connected to the pixel electrode PX1 through the through-hole TH. The pixel electrode PX1 is formed at a first pitch in the X direction, and at a third pitch in the Y direction, the scan signal line GL1 is formed at a second pitch in the Y direction, and the gate electrode GE1 is formed at the first pitch in the X direction. The image signal line DL1 is formed at the first pitch in the X direction, and the drain electrode DE1 is formed at the first pitch in the X direction, and at the third pitch in the Y direction.

The thin film transistor TFT1 is formed in such a manner as to align in the longitudinal direction (X direction). On the other hand, on the separate pattern M1, the scan signal line and concurrently gate electrode GL1/GE1, and the image signal line and concurrently drain electrode DL1/DE1 are formed, but the semiconductor layer SI1 and through-hole TH1 are not formed. The separate pattern M1 is also placed in such a manner as to align in the longitudinal direction (X direction). In the example shown in FIG. 29, the thin film transistor TFT1 and separate pattern M1 are formed alternately with respect to the transverse direction (Y direction).

As shown in FIG. 30, in the reflection type liquid crystal display device produced in the second specification are formed the thin film transistor TFT2 and separate pattern M2 for which two layers, namely the scan signal line and concurrently gate electrode GL2/GE2, and the image signal line and concurrently drain electrode DL2/DE2 are formed in the same layer.

The thin film transistor TFT2 is formed in such a manner as to align in the longitudinal direction (X direction). On the other hand, on the separate pattern M2, the scan signal line and concurrently gate electrode GL2/GE2, and the image signal line and concurrently drain electrode DL2/DE2 are formed, but the semiconductor layer SI2 and through-hole TH2 are not formed. The separate pattern M2 is also placed in such a manner as to align in the longitudinal direction (X direction). In the example shown in FIG. 30, the thin film transistor TFT2 and separate pattern M2 are formed alternately with respect to the transverse direction (Y direction).

Thin film transistors TFT2 are formed only in positions selected from the positions of thin film transistors TFT1 formed in such a manner as to align in the longitudinal direction in the first specification. The source electrode SE2 of the thin film transistor TFT2 is connected to the pixel electrode PX2 through through-hole TH2. In the second specification, the pixel electrode PX2 is formed at the third pitch in the X direction, and at the fourth pitch in the Y direction. However, the thin film transistor TFT2, the scan signal line and concurrently gate electrode GL2/GE2, and the image signal line and concurrently drain electrode DL2/DE2 have the first and second pitches, and are different in pitch from the pixel electrode.

As described above, in the reflection type liquid crystal display device of the seventh embodiment of the present invention, a common photo mask can be used when two layers are formed with the first and second specifications. Therefore, production costs when a plurality of reflection type liquid crystal display devices with different specifications are produced can further be reduced.

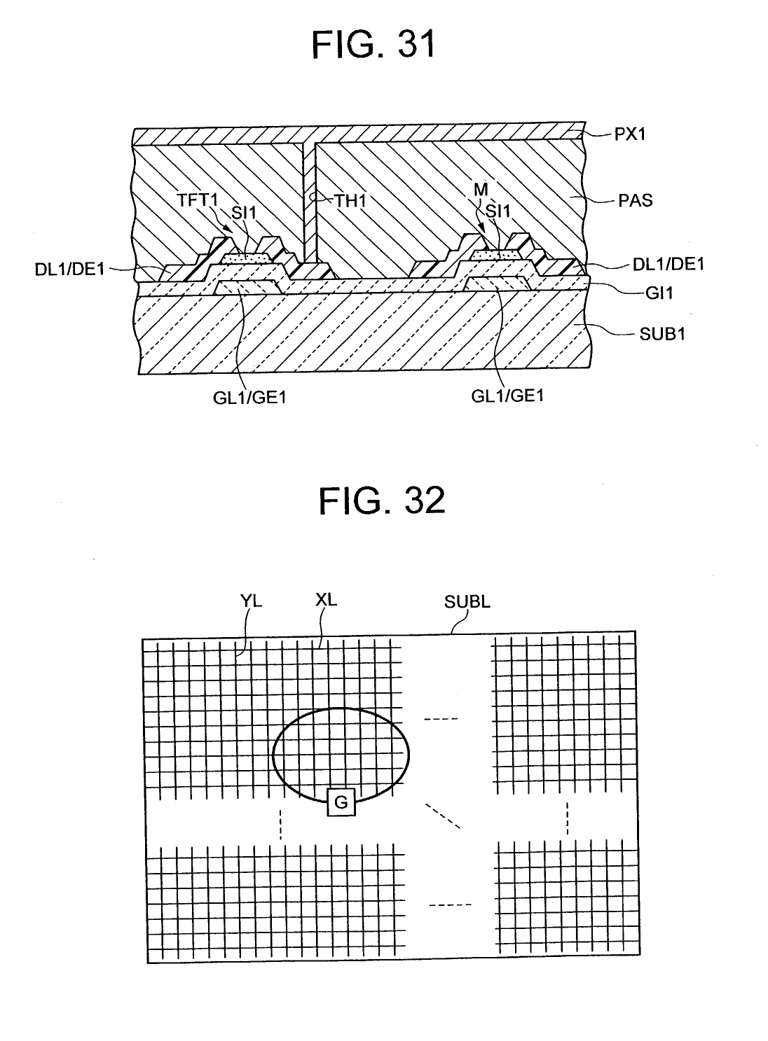

Now, the reflection type liquid crystal display device of the eighth embodiment of the present invention in which commonality of masks for layers is provided for three layers between the first and second specifications will briefly be described referring to FIG. 31.

FIG. 31 is a partial sectional view of the reflection type liquid crystal display device produced with the first specification when commonality of photo masks is provided for those for forming the scan signal line and concurrently gate electrode GL1/GE1, the semiconductor layer SI1, and the image signal line and concurrently drain electrode DL1/DE1 between the first and second specifications. The thin film transistor TFT1 and separate pattern M are formed on the substrate SUB1. For the thin film transistor TFT1 and separate pattern, three layers, namely the scan signal line and concurrently gate electrode GL1/GE1, the semiconductor layer SI1, and the image signal line and concurrently drain electrode DL1/DE1 are formed in the same layer. The source electrode SE1 of the thin film transistor TFT1 is connected to the pixel electrode PX1 through the through-hole TH1. The separate pattern M has no through-hole TH provided therein, and thus is connected to no pixel electrode PX.

In this embodiment, commonality of masks can be provided for three layers, thus making it possible to further reduce production costs.

The reflection type liquid crystal display device of the ninth embodiment of the present invention will now be described referring to FIGS. 32 to 39. In the reflection type liquid crystal display device of the ninth embodiment of the present invention, commonality of photo masks is provided for those that are used in the step of forming scan signal lines, image signal lines and semiconductor layers among several kinds of specifications when those specifications are different in any of pitch of pixel electrodes, substrate outer shape and size of the display screen.

Furthermore, in FIGS. 32 to 39, elements identical those of the aforesaid embodiments are given identical symbols to avoid duplication of description. Reference symbol OPAS denotes a coating type insulation film.

FIG. 32 is a schematic diagram of a large transparent insulation substrate that is used when the reflection type liquid crystal display device is produced. In this embodiment, on the almost entire surface of the large transparent insulation substrate SUBL1, the longitudinal line pattern XL is formed, and then the transverse line pattern YL is formed in such a manner that it crosses the longitudinal line pattern XL.

At this time, it is preferable that the pitch of the longitudinal line pattern XL is reduced to a minimum. For example, it is desirable that the pitch is identical to or smaller than the smallest pitch of pixel electrodes neighboring in the extending direction of the image signal line of the reflection type liquid crystal display device to be produced. The pitch of the transverse line pattern YL is desirably reduced to a minimum, which is, for example, identical to or smaller than the pitch of pixel electrodes neighboring in the extending direction of the scan signal line of the reflection type liquid crystal display device to be produced.

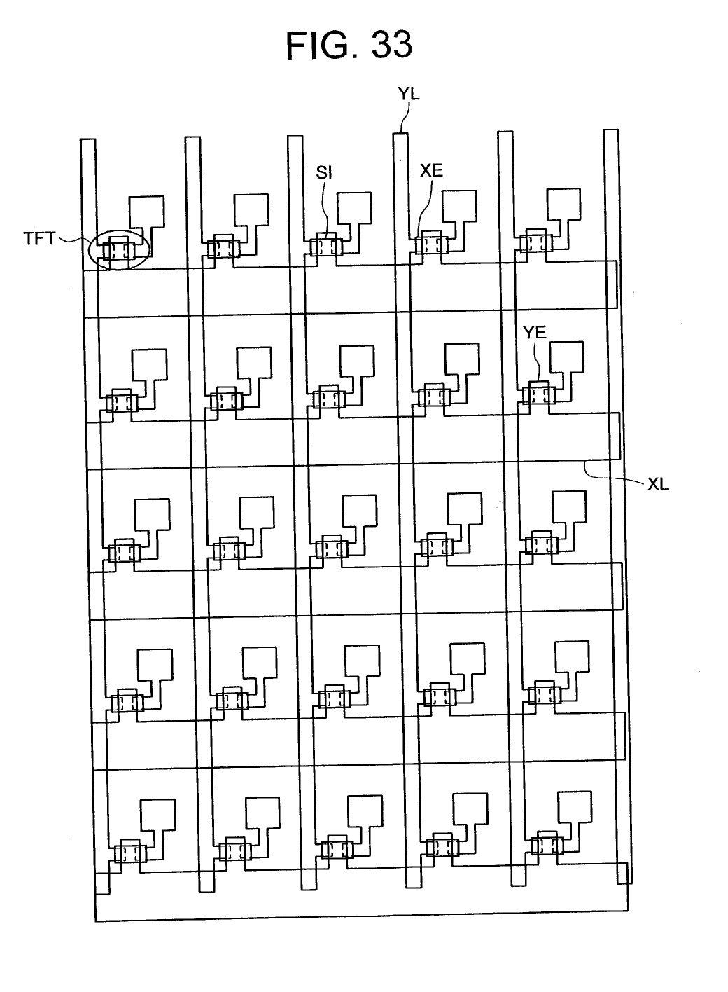

FIG. 33 is a plan view of the surrounded area G in FIG. 32 described above. It is a plan view of the reflection type liquid crystal display device at the time when the step (C) of the process flow described later is completed. In addition to the aforesaid longitudinal line pattern XL and transverse line pattern YL, the transverse electrode pattern YE connected to the longitudinal line pattern, the longitudinal electrode pattern XE connected to the transverse line pattern YL, the island pattern SI composed of semiconductor layer formed near the point of intersection between the longitudinal line pattern XL and the transverse line pattern YL, and the cross electrode pattern ME formed in such a manner as to be superimposed on a part of the semiconductor layer are formed in the large transparent substrate SUBL.

The transverse electrode pattern YE, longitudinal electrode pattern XE, island pattern SI and cross electrode pattern ME are formed so that they can be operated as the thin film transistor TFT, and when voltage equal to or greater than the threshold voltage Vth for the thin film transistor TFT is applied to between gate drains of the thin film transistor, the signal of the transverse line pattern YL is transferred to the cross electrode pattern ME through the semiconductor layer SI. Here, in the reflection type liquid crystal display device of this embodiment, the longitudinal line pattern XL to be used as the scan signal line GL, the transverse line pattern YL to be used as the image signal line DL and the island pattern SI to be used as the semiconductor layer of the thin film transistor TFT vary depending on the pixel pitch, substrate outer shape and display screen size.

In the plan view shown in FIG. 32, the line is formed not only in the display area of the reflection type liquid crystal display device, but also in the area in which terminal portions are formed.

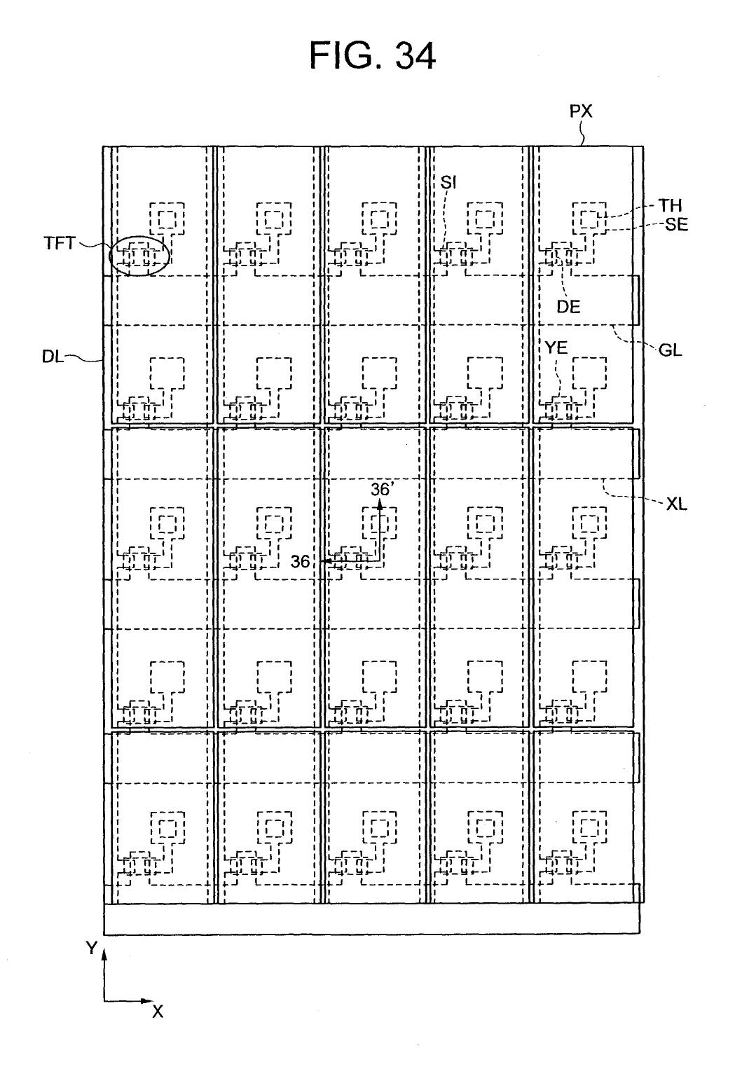

FIG. 34 is a plan view of the transparent insulation substrate SUB1 on which the thin film transistor TFT is formed when the reflection type liquid crystal display device of this embodiment is produced with the first specification. As shown in FIG. 34, the pitch of the pixel electrode PX neighboring in the extending direction of the scan signal line GL is identical to the pitch of the transverse line pattern YE. The image signal line DL formed in the display area is all used as the image signal line DL in the practical reflection type liquid crystal display device.

On the other hand, the pitch of the pixel electrode PX neighboring in the extending direction of the image signal line DL (Y direction) is twice as large as that of the longitudinal line pattern XL. The scan signal line GL, and the longitudinal line pattern XE that is not used in the first specification are aligned one after the other in the Y direction. The transverse electrode pattern YE, longitudinal electrode pattern XE, semiconductor layer SI and cross electrode pattern ME formed near the point of intersection between the image signal line DL and the scan signal line GL are elements of the thin film transistor TFT. On the source electrode SE of the thin film transistor TFT, the through-hole TH is selectively provided on the surface protection film (PAS) of the thin film transistor TFT to electrically connect the pixel electrode PX to the thin film transistor TFT. On the other hand, the transverse electrode pattern YE, longitudinal electrode pattern XE, semiconductor layer SI and cross electrode pattern ME formed near the point of intersection between the longitudinal line pattern XE and the image signal line DL are not used for the thin film transistor TFT. Therefore, the through-hole TH is not provided on the cross electrode pattern ME, and thus electrical isolation is provided between the pixel electrode PX and the thin film transistor TFT.

In the reflection type liquid crystal display device according to the first specification shown in FIG. 34, the case has been described where the pitch of the pixel electrode PX neighboring in the extending direction of the image signal line DL (Y direction), the pitch of the longitudinal pattern XL, the pitch of the pixel electrode PX neighboring in the extending direction of the scan signal line GL (X direction), and the pitch of the transverse pattern YL are integral multiples or submultiples of one another, but the reflection type liquid crystal display device of this embodiment can be achieved even when the pitch of the pixel electrode PX neighboring in the extending direction of the image signal line DL (Y direction), the pitch of the longitudinal line pattern (XL) and pitch of the pixel electrode PX neighboring in the extending direction of the scan signal line GL (X direction), and the pitch of the transverse line pattern YL have no submultiples.

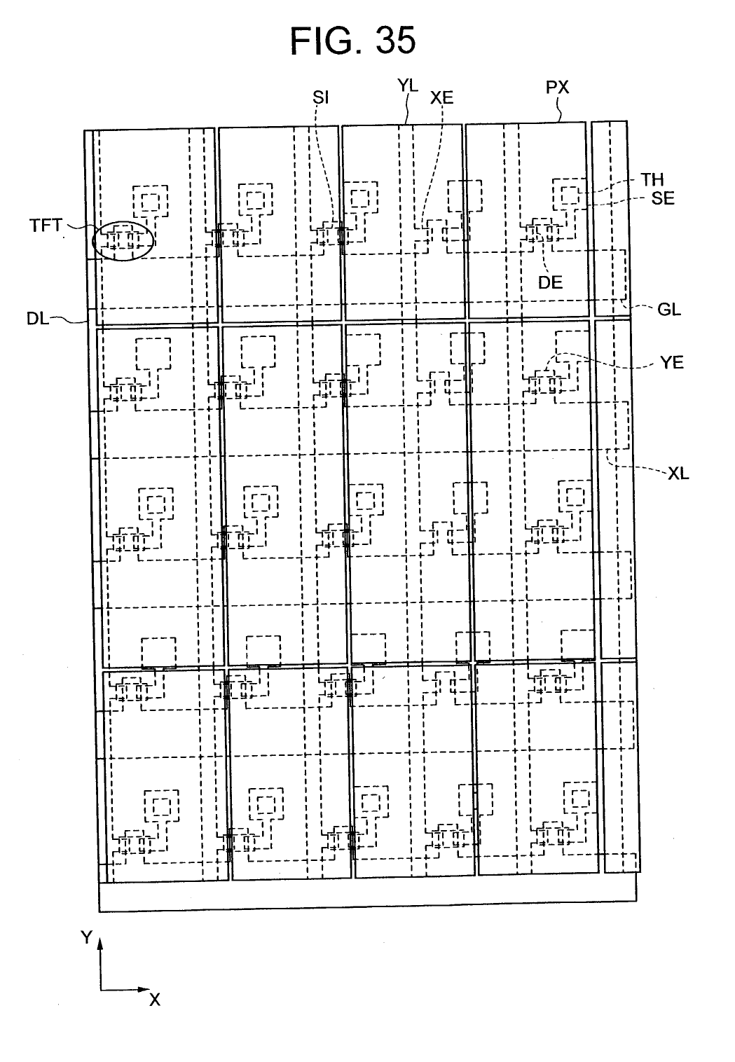

FIG. 35 is a plan view of the transparent insulation substrate SUB1 on which the thin film transistor is placed when the reflection type liquid crystal display device of this embodiment is produced with the second specification. FIG. 35 shows a case where the pitch of the pixel electrode PX neighboring in the extending direction of the scan signal line (X direction), the pitch of the transverse line pattern YL and pitch of the pixel electrode PX neighboring in the extending direction of the image signal line DL (Y direction), and the pitch of the longitudinal electrode pattern GL are not multiples or submultiples of one another. For the longitudinal line pattern GL that is used as a scan signal line at this time, there is no specific regularity in which the scan signal line GL and the transverse line pattern XL are aligned one after the other as described previously, for example, and the longitudinal line pattern XL placed near each pixel is used as the scan signal line GL. Also, for transverse line pattern YL that is used as an image signal line DL, there is no specific regularity, and the transverse line pattern YL placed near each pixel is used as the image signal line DL. Here, the transverse electrode pattern YE, longitudinal electrode pattern XE, semiconductor SI and cross electrode pattern ME formed near the point of intersection between the image signal line DL and the scan signal line GL are used as elements of the thin film transistor TFT in a same way as the first specification.

The case where the reflection type liquid crystal display device having first and second pitches of pixel electrodes has been described, but the above described technique can be applied using a similar methodology even when a reflection type liquid crystal display device having three different pixel pitches is produced.

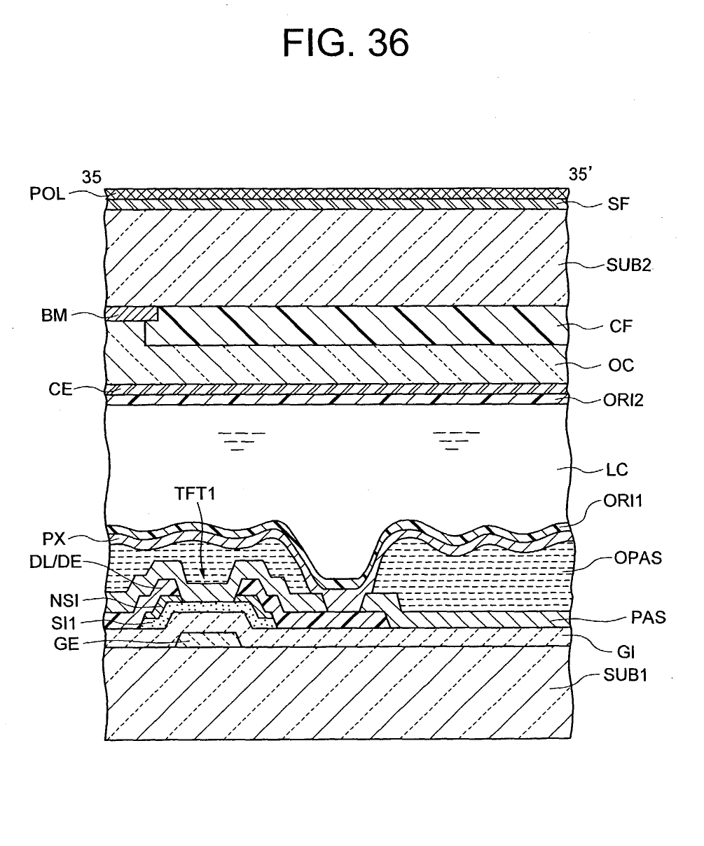

FIG. 36 is a cross sectional view of the reflection type liquid crystal display device taken along the line 36-36′ line shown in FIG. 34 described previously.

The reflection type liquid crystal display device of this embodiment has a structure in which a coating type insulation film is placed between the surface protection film PAS for the thin film transistor TFT and the pixel electrode PX. The coating type insulation film OPAS is a layer formed by a spin coating process or the like, and functions as a plarnarization film for alleviating step height in the lower layer. The coating type insulation film OPAS makes it possible to further reduce possibilities of disconnection occurring when the pixel electrode PX rode over a step height caused by the structure existing thereunder.

Also, if a film of relatively small permittivity is used as the coating type insulation film OPAS, a parasitic capacitance between the pixel electrode PX and the line pattern DL and electrode pattern DE can be reduced. Therefore, degradation of image quality resulting from the stray capacitance can be prevented. In addition, the pixel electrode PX is formed on the surface of the coating type insulation film OPAS with irregularities provided thereon, whereby the pixel electrode PX is provided on its surface with an irregularity pattern incorporating the irregularities on the surface of the coating type insulation OPAS. The irregularity pattern provided on the pixel electrode PX has a function to scatter light reflected from a reflection electrode, and thus brings about an advantage that display can be provided without using a film having a known scattering property. Other structural characteristics are the same as those of the reflection type liquid crystal display device of the first embodiment of the present invention.

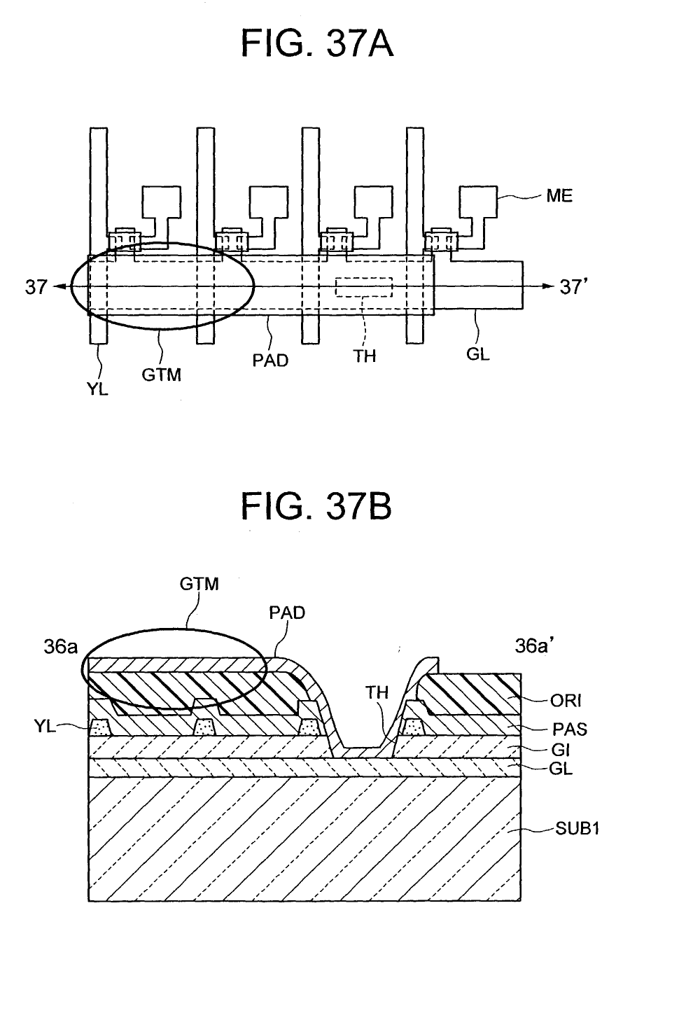

FIG. 37A is a plan view of the portion of the terminal for the scan signal line GTM in the reflection type liquid crystal display device of this embodiment, and FIG. 37B is a sectional view taken along the 37a-37a′ line of FIG. 37A.

As shown in FIG. 37A, for the terminal for the scan signal line GTM, the extending portion of the scan signal line GL and the transverse electrode pattern YE are formed in the area in which the portion of the terminal for the scan signal line on the transparent insulation substrate SUB1 is formed. In addition, the gate insulation film GI is formed in such a manner as to cover the scan signal line GL, and on the gate insulation film GI are provided the island pattern SI formed by the semiconductor layer, the transverse line pattern YL, the longitudinal electrode pattern XE connected to the transverse line pattern YL, and the cross electrode pattern ME.

In addition, the surface protection film PAS for the thin film transistor TFT and the coating type insulation film OPAS are formed one after another, and a part of the surface of the extending portion of the scan signal line GL is exposed by the through-hole TH provided in the gate insulation film GI and surface insulation film PAS. For avoiding a failure associated with shorts between the scan signal line GL and the transverse line pattern YL, the through-hole TH should be provided while avoiding a hole being bored in the transverse line pattern. The pad electrode PAD is provided on the through-hole TH to form the terminal for the scan signal line GTM. This pad electrode PAD is electrically connected to the scan signal line GL through the through-hole TH.

The pad electrode PAD is formed in such a manner as to ride over the step height of the transverse line pattern YE, but the coating type insulation film OPAS is provided between the transverse line pattern YL and the pad electrode PAD. Because the step height of the transverse line pattern YE is alleviated by the coating type insulation film OPAS, a failure associated with shorts resulting from the pad electrode PAD riding over the transverse pattern YE can be avoided.

In the reflection type liquid crystal display device of this embodiment, the transverse line pattern YL and the pad electrode PAD are placed with an insulation film therebetween, and therefore the pad electrode PAD can be formed in such a manner as to ride over the transverse line pattern YL. Thus, irrespective of the pitch of the transverse line pattern YL, the pad electrode PAD can be designed in any shape.

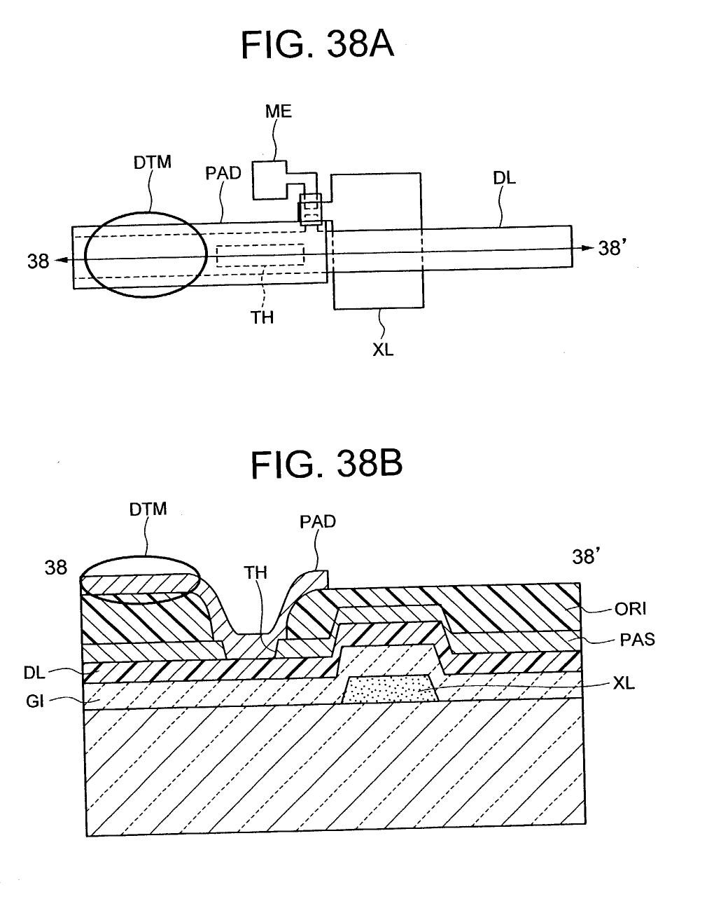

FIG. 38A is a plan view of the portion of the terminal for the image signal line DTM, and FIG. 38B is a sectional view of the 38-38′ line of FIG. 38A.

As shown in FIGS. 38A and 38B, for the terminal for the image signal line DTM, the longitudinal line pattern XL, the transverse electrode pattern YE, the gate insulation film GI, and the island pattern SI composed of semiconductor layer are formed on the transparent insulation substrate SUB1, and thereafter the extending portion of the image signal line DL and the longitudinal electrode pattern XE are formed in the area in which the terminal for the image signal line DTM is provided.

Thereafter, the surface protection film PAS for the thin film transistor TFT and the coating type insulation film OPAS are formed one after another, and the through-hole TH is provided in a part of the area in which the pad electrode PAD to be produced in a subsequent step will be provided, in the area in which the terminal for the image signal line DTM is provided. The pad electrode PAD is provided on the through-hole TH to form the terminal for the image signal line DTM. This pad electrode PAD is electrically connected to the image signal line DL through the through-hole TH.

In this embodiment, the longitudinal line pattern XL and the pad electrode PAD are placed with an insulation film therebetween, and therefore the pad electrode PAD can be formed in such a manner as to ride over the longitudinal line pattern XL. Thus, irrespective of the pitch of the longitudinal line pattern XL, the pad electrode PAD can be designed in any shape.

For the electric circuit of the reflection type liquid crystal display device of this embodiment, a description is not presented because it is identical to that of the reflection type liquid crystal display device of the first embodiment.

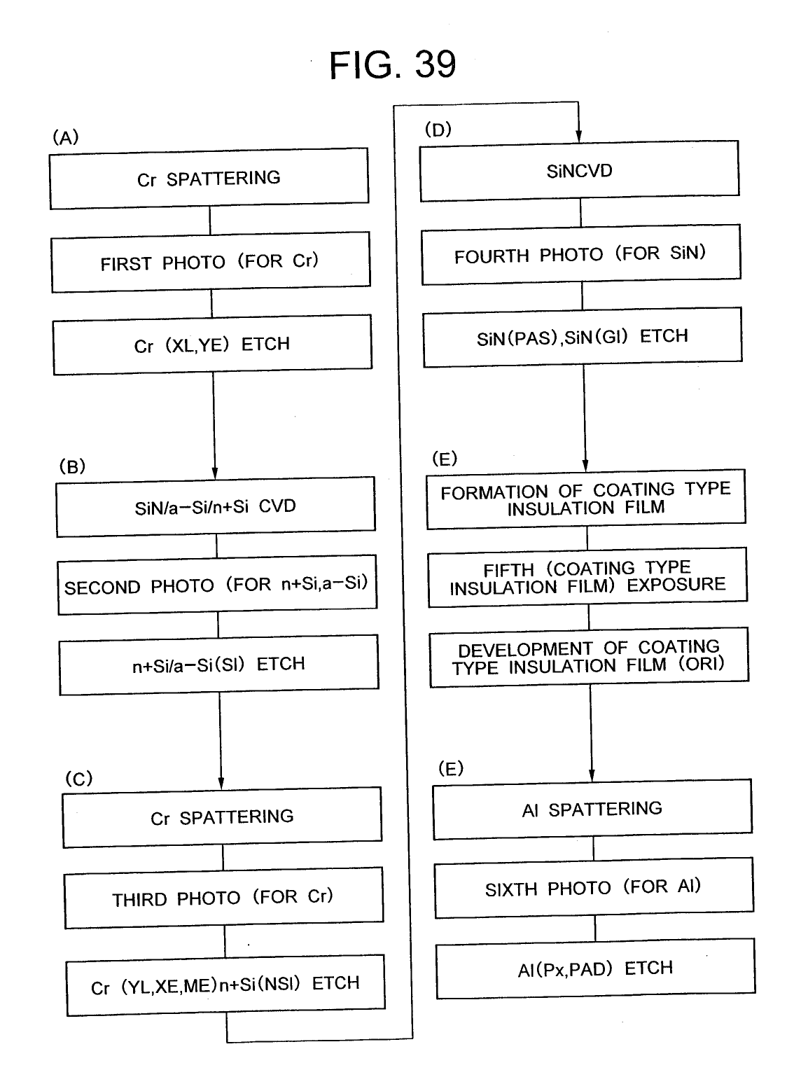

FIG. 39 shows a production process flow for the reflection type liquid crystal display device of this embodiment. According to this embodiment, specifically, the TFT substrate SUB1 is completed through a photolithography process comprising six steps of (A) to (F).

Those steps will be described below one after another. First, in the step (A), the transparent insulation substrate SUB1 is prepared, and then a Cr coating is provided on its entire surface in thickness of 100 to 300 nm, preferably 160 nm by, for example, sputtering process. Then, the photolithography technique is used to etch the Cr coating to form the longitudinal line pattern XL and transverse electrode pattern YE on the entire surface of the substrate.

Then, in the step (B), a silicon nitride coating is provided as the gate insulation film GI in thickness of about 200 to 700 nm, preferably 350 nm on the entire surface of the transparent insulation substrate SUB1 by, for example, plasma CVD process. In addition, an amorphous silicon coating is provided in thickness of 50 to 300 nm, preferably 200 nm on the entire surface of this gate insulation film GI by, for example, plasma CVD process, and then an amorphous silicon coating doped with phosphorous as an n type impurity is formed thereon in thickness of 10 to 100 nm, preferably 20 nm one after another. Then, the photolithography technique is used to etch the amorphous silicon coating to form the island pattern SI1 composed of semiconductor layer.

Then, in the step (C), the transparent insulation substrate SUB1 is prepared, and a Cr coating is provided on its entire surface in thickness of 100 to 300 nm, preferably 160 nm by, for example, sputtering process. Then, the photolithography technique is used to etch the Cr coating to form the transverse line pattern YL, longitudinal electrode pattern XE and cross electrode pattern ME on the entire surface of the substrate.

Thereafter, the amorphous silicon coating doped with phosphorous as an n type impurity is etched using as a mask a pattern with the Cr coating etched.

In the step (D), a silicon nitride coating as the surface protection film PAS for the thin film transistor TFT is provided in thickness of 200 to 900 nm, preferably 350 nm on the entire surface of the transparent insulation substrate SUB1 by, for example, plasma CVD process. Then, the photolithography technique is used to etch the surface protection film PAS to provide in the pixel area the contact hole TH for exposing a part of the upper surface of the source electrode SE of the thin film transistor TFT. In addition, in the area in which the scan signal line GTM is formed, the through-hole TH extending to the upper surface of the gate electrode GI located in the lower layer of the surface protection film PAS is provided to expose a part of the scan signal line GL. The through hole TH for exposing the extending portion of the image signal line DL is provided in the area in which the terminal for the image signal line DTM is formed.

In the step (E), a coating type insulation film OPAS composed of an insulation film of various kinds of organic resin such as a polyimide based material, acryl based polymer, epoxy based polymer and benzicyclobutene based polymer, or an inorganic polymer containing Si that is soluble in an organic solvent, for example an SOG film is provided on the entire surface of the transparent insulation substrate SUB1 in thickness of 200 nm to 4 μm, preferably 1 to 3 μm by, for example, spin coat process. Then, the photolithography technique is used to provide the through-hole in the position at which the through-hole is bored in the step (D), on the surface protection film PAS, and form an irregularity pattern in the position at which the pixel electrode is placed.

Then, in the step (F), an alloy coating having Al as a main component and including Nd (hereinafter referred to as “Al—Nd coating”), which functions as the pixel electrode, is provided in thickness of 50 to 300 nm, preferably 200 nm on the entire surface of the transparent insulation substrate SUB1 by, for example, sputtering process. Then, the photolithography technique is used to etch the Al—Nd coating to form the pixel electrode PX connected to the source electrode SE through the through-hole TH in the pixel area, and form the pad electrode PAD for connection in the area in which the terminal for the scan signal line GTM and the terminal for the image signal line DTM are formed.

Through the steps described above, the structure of the TFT substrate is completed.

According to this embodiment, on the almost entire surface of the large transparent insulation substrate SUBL, the longitudinal line pattern XL is formed, and then the transverse line pattern YL is formed in such a manner that it crosses the longitudinal line pattern. The pitch of the longitudinal line pattern XL is reduced to a minimum, which is, for example, identical to or smaller than the smallest pitch of pixel electrodes neighboring in the extending direction of the image signal line of the reflection type liquid crystal display device to be produced. The pitch of the transverse line pattern is also reduced to a minimum, which is, for example, identical to or smaller than the pitch of pixel electrodes neighboring in the extending direction of the scan signal line of the reflection type liquid crystal display device to be produced. In addition, the transverse electrode pattern YE connected to the longitudinal line pattern, the longitudinal electrode pattern XE connected to the transverse line pattern YL, the island pattern SI composed of semiconductor layer formed near the point of intersection between the longitudinal line pattern XL and the transverse line pattern YL, and the cross electrode pattern ME formed in such a manner as to be superimposed on a part of the semiconductor layer are provided to form the thin film transistor TFT.

It is possible to form the thin film transistor, image signal line and scan signal line at a minimum possible pitch, followed by forming the pixel electrode at the same pitch. In addition, the cross electrode pattern (source electrode) of one thin film transistor TFT is selectively connected to the pixel electrode, thereby making it possible to form the pixel electrode at a pitch larger than that of the thin film transistor, image signal line and scan signal line.

Therefore, commonality of masks can be provided for at least any of masks for use in preparation of the scan signal line GL, the image signal line DL, and the semiconductor layer SI, source electrode SE, gate electrode GE and drain electrode DE constituting the thin film transistor TFT when reflection type liquid crystal display devices of specifications different in at least one of pitch of pixel electrodes, display screen size and substrate outer shape.

As described above, according to the reflection type liquid crystal display device of each embodiment of the present invention, at least one of the transverse line pattern, longitudinal line pattern, longitudinal electrode pattern, transverse electrode pattern, semiconductor layer and cross electrode pattern is formed, wherein the pitch of the transverse line pattern, the longitudinal electrode pattern provided in the extending direction of the scan signal line, the transverse electrode pattern provided in the extending direction of the scan signal line, and the semiconductor layer provided in the extending direction of the scan signal line is different from the pitch of the pixel electrode neighboring in the extending direction of the scan signal line, and the pitch of the longitudinal line pattern, the longitudinal electrode pattern provided in the extending direction of the image signal line, the transverse electrode pattern provided in the extending direction of the image signal line and the semiconductor layer provided in the extending direction of scan signal line is different from the pitch of the pixel electrode neighboring in the extending direction of the image signal line, whereby commonality of photo masks can be provided for those that are used when reflection type liquid crystal display devices of specifications different in at least one of pitch of pixel electrodes, display screen size and substrate outer shape.

In the reflection type liquid crystal display device of each embodiment described above, the case where anti-stagger type thin film transistor each having amorphous silicon as a semiconductor layer are used as switching elements has been described, but commonality of photo masks can be provided between the first and second specifications even when normal-stagger type or coplanar type thin film transistors, thin film transistors each having multicrystal silicon as a semiconductor layer, or the like are used.

Also, in the reflection type liquid crystal display device of each embodiment, a Cr coating is used as a scan signal line, gate electrode, image signal line, drain electrode and source electrode, but in addition thereto, a Cr alloy coating having Cr as a main component, an Al layer, an Al alloy coating having Al as a main component, Ab, an Ag alloy coating having Ag as a main component or the like may also be used.

In addition, in the reflection type liquid crystal display device of each embodiment, an Al—Nd alloy coating is used as an pixel electrode, but commonality of photo masks can be provided even when in addition to the above alloy coating, an alloy coating having Al as a main component and containing Ti and Ta, Ag, and an alloy coating having Ag as a main component or the like is used as a pixel electrode.

In the reflection type liquid crystal display device of each embodiment, the pad electrode is formed simultaneously in the step of forming the pixel electrode, but commonality of photo masks can be provided even if a step is newly added for forming the pad electrode.

Furthermore, in each embodiment, cases have been described where commonality of photo masks is provided when reflection type liquid crystal display devices of two different specifications are produced, but even when reflection type liquid crystal display devices of three different specifications are produced, commonality of photo masks can be provided by forming patterns consistent with respective specifications.

Cases have been described where the gate electrode and scan signal line are formed with same materials and in the same step, but in the case where the gate electrode and the scan signal line are formed in different steps, commonality of photo masks can be provided for the photo mask that is used in formation of the gate electrode by forming the transverse electrode pattern at the time when the gate electrode is formed, and commonality of photo masks can be provided for the photo mask that is used in the step of forming the scan signal line by forming the longitudinal line pattern at the time when the scan signal line is formed.

Cases have been described where the source electrode, drain electrode and image signal line are formed with same materials and in the same step, but in the case where they are each formed in different steps, commonality of photo masks can be provided for the photo mask that is used in formation of the source electrode by forming the cross electrode pattern at the time when the source electrode is formed, commonality of photo masks can be provided for the photo mask that is used in formation of the drain electrode by forming the longitudinal electrode pattern at the time when the drain electrode is formed, and commonality of photo masks can be provided for the photo mask that is used in the step of forming the image signal line by forming the transverse line pattern at the time when the image signal line is formed.

It is also possible to connect the whole transverse electrode pattern in the area opposite to the terminal portion of the image signal line, followed by applying a certain electric potential thereto to provide a retention capacitance of liquid crystal.

Cases have been described where commonality of photo masks is provided between specifications different in pitch of pixel electrodes, but commonality of photo masks can also be provided between specifications different in substrate outer shape and display screen size based on a similar concept as the second embodiment.

Application of the coating type insulation film is not necessarily required, but if the coating type insulation film is applied, a new effect of providing the pixel electrode with scatterablility can be added in addition to effects of reducing possibilities of disconnection by a lower step and reducing a parasitic capacitance.

The present invention has been described with the embodiments, but the present invention should not be limited thereto. It will be apparent to those skilled in the art that other various changes, modifications and combinations can be applied.

According to the present invention, commonality of photo masks can be provided for at least one of photo masks when reflection type liquid crystal display devices are produced with specifications different in pitch of pixel electrode or the like. Therefore, production costs can be reduced when reflection type liquid crystal display devices different in pixel pitches or the like.

What is claimed is:

1. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes;
a layer insulation film covering said scan signal lines, said image signal lines and said thin film transistors;
through-holes provided in the layer insulation film; and
reflection type pixel electrodes connected to said source electrodes via the through-holes,
wherein a photo mask for use in production of at least two types of reflection type liquid crystal display devices with at least two specifications, namely a first specification and a second specification with a pixel pitch different from that of the first specification, which is used in at least one of a first step of forming said scan signal lines and said gate electrode, a second step of forming said semiconductor layer, and a third step of forming said image signal lines, said source electrode and said drain electrode, is used in common in both said first specification and said second specification.

2. The method according to claim 1, comprising the steps of:
(a) determining which of said first specification and said second specification is used to produce the reflection type liquid crystal display device;
(b) selecting a first photo mask set for use in production process with said first specification, and using the first photo mask set to carry out said first to third steps if it is determined in said step (a) that the reflection type liquid crystal display device is produced with said first specification; and
(c) carrying out at least one of said first to third steps using a second photo mask set for use in production process with said second specification, the second photo mask set including a common photo mask with the first photo mask set having in common therewith the photo mask for use in at least one of said first to third steps, if it is determined in said step (a) that the reflection type liquid crystal display device is produced with said second specification.

3. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line, and forming a longitudinal line pattern that extends substantially in parallel with said scan signal line, and in which the pitch in the extending direction of said image signal line is different from that of said scan signal line;
(b) forming a semiconductor layer in an area superimposed on said gate electrode;
(c) forming said image signal line, and forming said source electrode and said drain electrode in areas located on both sides of said gate electrode and superimposed on said semiconductor layer to form said thin film transistor; and
(d) forming a layer insulation film covering said thin film transistor, providing a through-hole for exposing the upper surface of the source electrode of said thin film transistor in the layer insulation film, and forming said pixel electrode connected to said source electrode via said through-hole at a pitch identical to the pitch in the extending direction of said scan signal line and said image signal line.

4. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line, and forming a transverse electrode pattern in which at least any one of the pitch in the extending direction of said image signal line and the pitch in the extending direction of said scan signal line is different from that of said gate electrode;
(b) forming a semiconductor layer in an area superimposed on said gate electrode;
(c) forming said image signal line, and forming said source electrode and said drain electrode in areas located on both sides of said gate electrode and superimposed on said semiconductor layer to form said thin film transistor; and
(d) forming a layer insulation film covering said thin film transistor, providing a through-hole for exposing the upper surface of the source electrode of said thin film transistor in the layer insulation film, and forming the pixel electrode connected to said source electrode via said through-hole at a pitch identical to the pitch of said gate electrode.

5. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line;
(b) forming a semiconductor layer in an area superimposed on said gate electrode, and forming an island pattern in which at least any one of the pitch in the extending direction of said image signal line and the pitch in the extending direction of said scan signal line is different from that of said semiconductor layer;
(c) forming said image signal line, and forming said source electrode and said drain electrode in areas located on both sides of said gate electrode and superimposed on said semiconductor layer to form said thin film transistor; and
(d) forming a layer insulation film covering said thin film transistor, providing a through-hole for exposing the upper surface of the source electrode of said thin film transistor in the layer insulation film, and forming the pixel electrode connected to said source electrode via said through-hole at a pitch identical to the pitch of semiconductor layer.

6. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line;
(b) forming a semiconductor layer in an area superimposed on said gate electrode;
(c) forming said image signal line, and forming said source electrode and said drain electrode in areas located on both sides of said gate electrode and superimposed on said semiconductor layer to form said thin film transistor, and forming a transverse line pattern that extends substantially in parallel with said image signal line, and in which the pitch in the extending direction of said scan signal line is different from that of said image signal line; and
(d) providing a through-hole for exposing the upper surface of said source electrode in the layer insulation film covering said thin film transistor, and forming the pixel electrode connected to said source electrode via said through-hole at a pitch identical to the pitch in the extending direction of said image signal line and said scan signal line.

7. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the-points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line;
(b) forming a semiconductor layer in an area superimposed on said gate electrode;
(c) forming said image signal line, and forming said source electrode and said drain electrode in areas located on both sides of said gate electrode and superimposed on said semiconductor layer to form said thin film transistor, and forming a longitudinal line pattern that extends substantially in parallel with said source electrode, and in which at least one of the pitch in the extending direction of said scan signal line and the pitch in the extending direction of said image signal line is different from that of said source electrode; and
(d) forming a layer insulation film in such a manner as to cover said thin film transistor, providing a through-hole for exposing the upper surface of said source electrode in the layer insulation film, and forming the pixel electrode connected to said source electrode via said through-hole at a pitch identical to the pitch of said source electrode.

8. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode extending from the scan signal line;
(b) forming a semiconductor layer in an area superimposed on said gate electrode;
(c) forming said image signal line, and forming said source electrode and said drain electrode in areas located on both sides of said gate electrode and superimposed on said semiconductor layer to form said thin film transistor, and forming a cross electrode pattern that extends substantially in parallel with said drain electrode, and in which at least one of the pitch in the extending direction of said scan signal line and the pitch in the extending direction of said image signal line is different from that of said drain electrode; and
(d) forming a layer insulation film in such a manner as to cover said thin film transistor, providing a through-hole for exposing the upper surface of said source electrode in the layer insulation film, and forming the pixel electrode connected to said source electrode via said through-hole at a pitch identical to the pitch of said drain electrode.

9. A method of producing a reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said source electrodes, comprising the steps of:
(a) forming said scan signal line and said gate electrode;
(b) forming a semiconductor layer in an area superimposed on said gate electrode;
(c) forming said image signal line, said source electrode and said drain electrode, and forming said scan signal line, said image signal line and said thin film transistor; and
(d) forming a layer insulation film covering said thin film transistor, selectively providing a through-hole for exposing the upper surface of the source electrode in the layer insulation film, and forming the pixel electrode having desired pitches in the extending direction of said scan signal line and in the extending direction of said image signal line via the selected through-hole on said layer insulation film including said selected through-hole.

10. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, source electrodes, gate electrodes and drain electrodes; and
reflection type pixel electrodes connected to said thin film transistors and having a function as a reflecting plate,
wherein the reflection type liquid crystal display device further comprises:
an island pattern having a pitch different from at least one of the pitch of said pixel electrode neighboring in the extending direction of said image signal line and the pitch of said pixel electrode neighboring in the extending of said scan signal line, said island pattern formed in matrix form and placed with a specific regularity.

11. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, source electrodes, gate electrodes and drain electrodes; and
reflection type pixel electrodes connected to said thin film transistors and having a function as a reflecting plate,
wherein the reflection type liquid crystal display device further comprises:
an island pattern formed in the same layer as said semiconductor layer and forming a matrix pattern having a predetermined regularity in cooperation with said semiconductor layer, said island pattern placed in such a manner that said matrix pattern has a pitch different from at least one of the pitch of said pixel electrode neighboring in the extending direction of said image signal line and the pitch of said pixel electrode neighboring in the extending direction of said scan signal line.

12. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a plurality of transverse line patterns each formed in the same layer as and substantially in parallel with said image signal line, said transverse line patterns having a specific regularity in which the pitch of said transverse line pattern in the extending direction of said scan signal line is different from the pitch of the pixel electrode neighboring in the extending direction of said scan signal line.

13. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a plurality of transverse line patterns each formed in the same layer as and substantially in parallel with said image signal line, and forming a first stripe pattern group having a predetermined regularity in cooperation with said image signal line, said transverse line patterns placed in such a manner that said first stripe pattern in the extending direction of said scan signal line has a pitch different from that of the pixel electrode neighboring in the extending direction of said scan signal line.

14. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, source electrodes, gate electrodes and drain electrodes; and
reflection type pixel electrodes connected to said thin film transistors and having a function as a reflecting plate,
wherein the reflection type liquid crystal display device further comprises:
a plurality of longitudinal line patterns each formed in the same layer as and substantially in parallel with said scan signal line, said longitudinal line patterns having a predetermined regularity in which the pitch of said longitudinal line pattern in the extending direction of said image signal is different from the pitch of the pixel electrode neighboring in the extending direction of said image signal line.

15. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a plurality of longitudinal line patterns each formed in the same layer as and substantially in parallel with said scan signal line, and forming a second stripe pattern group having a predetermined regularity in cooperation with said scan signal line, said longitudinal line patterns placed in such a manner that the pitch of said stripe pattern neighboring in the extending direction of said image signal line is different from the pitch of said pixel electrode neighboring in the extending direction of said image signal line.

16. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a transverse electrode pattern having a pitch different from at least one of the pitch of the pixel electrode neighboring in the extending direction of said image signal line and the pitch of the pixel electrode neighboring in the extending direction of said scan signal line, said transverse electrode pattern placed in the same layer as said gate electrode with a specific regularity.

17. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a transverse electrode pattern formed in the same layer as the gate electrode of said thin film transistor and forming a second matrix pattern having a predetermined regularity in cooperation with said gate electrode, said transverse electrode pattern placed in such a manner that said second matrix pattern has a pitch different from at least one of the pitch of in the extending direction of said image signal line and the pitch in the extending direction of said scan signal line.

18. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors formed on at least part of the areas near the points of intersection between said scan signal lines and said image signal lines and including semiconductor layers, gate electrodes, source electrodes and drain electrodes; and
reflection type pixel electrodes connected to said thin film transistors and having a function as a reflecting plate,
wherein the reflection type liquid crystal display device further comprises:
a longitudinal electrode pattern having a pitch different from at least one of the pitch of the pixel electrode neighboring in the extending direction of said image signal line and the pitch of the pixel electrode neighboring in the extending direction of said scan signal line, and a cross electrode pattern placed opposite to the longitudinal electrode pattern, said longitudinal electrode pattern and said cross electrode pattern each formed in the same layer as said drain electrode in matrix form with a specific regularity.

19. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and having semiconductor layers, gate electrodes, source electrodes and drain electrodes; and
reflection type pixel electrodes connected to said thin film transistors and having a function as a reflecting plate,
wherein the reflection type liquid crystal display device further comprises:
a longitudinal electrode pattern formed in the same layer as said drain electrode and forming a third matrix pattern group having a predetermined regularity in cooperation with said drain electrode, said longitudinal electrode pattern placed in such a manner that the pitch of said third matrix pattern is different from the pitch of the pixel electrode neighboring in the extending direction of said scan signal line, and a cross electrode pattern formed in the same layer as said source electrode and opposite to said longitudinal electrode pattern, and forming a fourth matrix pattern group having a predetermined regularity in cooperation with said source electrode, said cross electrode pattern placed in such a manner that the pitch of said fourth matrix pattern in the extending direction of said image signal line is different from the pitch of the pixel electrode neighboring in the extending direction of said image signal line.

20. A reflection type liquid crystal display device, comprising:
a pair of substrates;
a liquid crystal layer held between the pair of substrates;
a common signal electrode formed on one of said pair of substrates and having transparency;
a plurality of scan signal lines formed on the other substrate;
a plurality of image signal lines substantially orthogonal to the scan signal lines;
thin film transistors each formed near the points of intersection between said scan signal lines and said image signal lines and having semiconductor layers, gate electrodes, source electrodes and drain electrodes; and
reflection type pixel electrodes connected to said thin film transistors and having a function as a reflecting plate,
wherein the reflection type liquid crystal display device is provided with at least one of:
a first combined pattern formed by a plurality of longitudinal line patterns placed in the same layer as and substantially in parallel with said scan signal line and said scan signal line, and having a predetermined regularity;
a second combined pattern formed by a plurality of transverse line patterns placed in the same layer as and substantially in parallel with said image signal line and said image signal line, and having a predetermined regularity;
a third combined pattern formed by a longitudinal electrode pattern formed in matrix form in the same layer as said drain electrode in such a manner as to extend from said transverse pattern in a direction substantially perpendicular to the transverse pattern and said drain electrode, and having a predetermined regularity;
a fourth combined pattern formed opposite to said longitudinal electrode pattern in the same layer as said source electrode and said source electrode, and having a predetermined regularity;
a fifth combined pattern formed by a transverse electrode pattern formed in matrix form in the same layer as said gate electrode in such a manner as to extend from said longitudinal pattern in a direction substantially perpendicular to the longitudinal pattern and said gain electrode, and having a predetermined regularity; and
a sixth combined pattern formed by an island pattern formed in the same layer as said semiconductor layer and in matrix form and said semiconductor layer, and having a predetermined regularity,
wherein at least one of the formed combined patterns of said first to sixth combined patterns has a pitch different from the pitch of said pixel electrode.

21. The reflection type liquid crystal display device according to claim 12, further comprising an image line driving external circuit for driving said image signal line,
wherein in the terminal portion of said image signal line, a pad electrode for connection to said image line driving external circuit, and a joint for connecting said pad electrode to said image signal line are formed selectively with respect to said transverse line.

22. The reflection type liquid crystal display device according to claim 14, further comprising a scan line driving external circuit for driving said scan signal line,
wherein in the terminal portion of said scan signal line, a pad electrode for connection to said scan line driving external circuit, and a joint for connecting said pad electrode to said image signal line are formed selectively with respect to said longitudinal line.

23. The reflection type liquid crystal display device according to claim 10, wherein a gate electrode,
wherein a source electrode and a drain electrode are formed in said semiconductor layer selectively with respect to said island pattern.

24. The reflection type liquid crystal display device according to claim 10,
wherein a joint for connecting said source electrode to said pixel electrode is formed selectively with respect to said cross electrode.

25. The reflection type liquid crystal display device according to claim 10,
wherein said transverse line pattern is coupled to a fixed electric potential on the opposite side to the terminal of said image signal line.

26. The reflection type liquid crystal display device according to claim 10,
wherein said longitudinal line pattern is coupled to a fixed electric potential on the opposite side to the terminal of said scan signal line.

27. The reflection type liquid crystal display device according to claim 10,
wherein said transverse line pattern is made to be at the same potential as said common electrode on the opposite side to the terminal of said image signal line.

28. The reflection type liquid crystal display device according to claim 10,
wherein said longitudinal line pattern is made to be at the same potential as said common electrode on the opposite side to the terminal of said scan signal line.

29. A reflection type liquid crystal display device comprising:
a first substrate having a common electrode having transparency;
a second substrate placed opposite to the first substrate, in which a plurality of pixel areas are demarcated in matrix form on the surface opposite to said first substrate; and
a liquid crystal layer held between said first substrate and said second substrate,
wherein the reflection type liquid crystal display device further comprises:
a plurality of pixel electrodes each formed in the same area of each of a plurality of said pixel areas and having a function as a reflecting plate;
thin film transistors formed in matrix form under said pixel electrodes and on said substrate, having a pitch smaller than at least one of the pitches in transverse and longitudinal directions of said pixel electrodes, and having semiconductor layers, source electrodes, drain electrodes and gate electrodes;
image signal lines formed along a row of said thin film transistors aligned in the transverse direction;
scan signal lines formed along a line of said thin film transistors aligned in the longitudinal direction;
a layer insulation film formed on said first substrate in such a manner as to cover the thin film transistors, said layer insulation film provided on its upper surface with said pixel electrodes; and
through-holes provided in the layer insulation film so that the upper surfaces of said source electrodes are exposed, said through-holes connecting said pixel electrodes to said thin film transistors on a one-by-one basis.

30. The reflection type liquid crystal display device according to claim 29,
wherein the thin film transistors connected to said pixel electrodes through said through-holes are placed in such a manner as to align in at least one of longitudinal and transverse directions.
